(19) United States
(12) Patent Application Publication
(10) Pub. No.: US 2021/0345390 A1
(43) Pub. Date: Nov. 4, 2021

(54) USER TERMINAL AND RADIO COMMUNICATION METHOD

(71) Applicant: NTT DOCOMO, INC., Tokyo (JP)

(72) Inventors: Masaya Okamura, Tokyo (JP); Hiroki Harada, Tokyo (JP); Yuki Matsumura, Tokyo (JP)

(73) Assignee: NTT DOCOMO, INC., Tokyo (JP)

(21) Appl. No.: 17/266,812

(22) PCT Filed: Aug. 9, 2018
(86) PCT No.: PCT/JP2018/029996

§ 371 Date: Feb. 8, 2021

(51) Int. Cl. H04W 72/12; H04L 5/00

(52) U.S. Cl. CPC H04W 72/1289; H04L 5/0048

(57) ABSTRACT

A user terminal according to one aspect of the present disclosure includes: a receiving section that receives information for controlling transmission of an uplink channel; and a control section that, when transmission of a first uplink channel and a second uplink channel is instructed in overlapping durations, performs control to transmit one of the first and second uplink channels in the durations, and further transmit a rest of symbols that do not overlap the durations among symbols of other one of the first and second uplink channels. According to one aspect of the present disclosure, it is possible to appropriately support simultaneous transmission of a plurality of uplink channels.

### TECHNICAL FIELD

The present disclosure relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of a larger capacity and higher sophistication than those of LTE (LTE Rel. 8 and 9), LTE-Advanced (LTE-A and LTE Rel. 10, 11, 12 and 13) has been specified.

LTE successor systems (also referred to as, for example, Future Radio Access (FRA), the 5th generation mobile communication system (5G), 5G₊ (plus), New Radio (NR), New radio access (NX), Future generation radio access (FX) or LTE Rel. 14, 15 or subsequent releases) are also studied.

In legacy LTE systems (e.g., LTE Rel, 8 to 14), a base station notifies a user terminal (UE: User Equipment) of a transmission instruction of an uplink shared channel (PUSCH: Physical Uplink Shared Channel) by using Downlink Control Information (DCI).

### CITATION LIST

### Non-Patent Literature

Non-Patent Literature 1: 3GPP TS 36.300 V8.12.0 “Evolved Universal Terrestrial Radio Access (E-U-RA) and Evolved Universal Terrestrial Radio Access Network (E-UTRAN); Overall description; Stage 2 (Release 8)”, April 2010

### SUMMARY OF INVENTION

### Technical Problem

It is studied for a future radio communication system (e.g., NR) to use beam forming. A UE that uses analog beam forming can form only one beam at a certain timing.

Hence, there is a case where, when, for example, a PUSCH and a PUSCH are simultaneously transmitted, one of the PUSCHs can only be transmitted. However, according to NR, study on which PUSCH to transmit in a case of PUSCH-PUSCH simultaneous transmission has not yet advanced. Unless transmission is controlled according to an appropriate rule during PUSCH-PUSCH simultaneous transmission, there is a risk that there is discrepancy between the base station and the UE, and a communication throughput lowers.

It is therefore one of objects of the present disclosure to provide a user terminal and a radio communication method that can appropriately support simultaneous transmission of a plurality of uplink channels.

### Solution to Problem

A user terminal according to one aspect of the present disclosure includes: a reception section that receives information for controlling transmission of an uplink channel; and a control section that, when transmission of a first uplink channel and a second uplink channel is instructed in overlapping durations, performs control to transmit one of the first ad second uplink channels in the durations, and further transmit a rest of symbols that do not overlap the durations among symbols of other one of the first and second uplink channels.

### Advantageous Effects of Invention

According to one aspect of the present disclosure, it is possible to appropriately support simultaneous transmission of a plurality of uplink channels.

### BRIEF DESCRIPTION OF DRAWINGS

FIG. 1 is a diagram illustrating one example of beam forming control that uses SRSs.

FIG. 2 is a diagram Illustrating one example of beams used in scenarios 1-A and 2-A.

FIG. 3 is a diagram illustrating one example of beams used in scenarios 1-B and 2-B

FIG. 4 is a diagram illustrating one example of a task of UL CA.

FIG. 5 is a diagram illustrating one example of PUSCH transmission in a case where the numbers of PUSCH symbols of transmission beams of respective CCs are different, and PUSCH transmission start timings are also different.

FIG. 6 is a diagram illustrating another example of PUSCH transmission in a case where the numbers of PUSCH symbols of transmission beams of respective CCs are different, and PUSCH transmission start timings are also different.

FIG. 7 is a diagram illustrating one example of PUSCH transmission in a case where the numbers of PUSCH symbols of transmission beams of respective CCs are different, and PUSCH transmission start timings are the same.

FIG. 8 is a diagram illustrating another example of PUSCH transmission in a case where the numbers of PUSCH symbols of transmission beams of respective CCs are different, and PUSCH transmission start timings are the same.

FIG. 9 is a diagram illustrating still another example of PUSCH transmission in a case where the numbers of PUSCH symbols of transmission beams of respective CCs are different, and PUSCH transmission start timings are also different.

FIG. 10 is a diagram illustrating still another example of PUSCH transmission in a case where the numbers of PUSCH symbols of transmission beams of respective CCs are different, and PUSCH transmission start timings are the same.

FIGS. 11A and 11B are diagrams illustrating one example of a situation assumed in a third embodiment.

FIG. 12 is a diagram illustrating one example of PUSCH transmission according to the third embodiment.

FIG. 13 is a diagram illustrating another example of PUSCH transmission according to the third embodiment.

FIG. 14 is a diagram illustrating one example of a schematic configuration of a radio communication system according to one embodiment.

FIG. 15 is a diagram illustrating one example of an overall configuration of a base station according to the one embodiment.

FIG. 16 is a diagram illustrating one example of a function configuration of the base station according to the one embodiment.

FIG. 17 is a diagram illustrating one example of an overall configuration of a user terminal according to the one embodiment.

FIG. 18 is a diagram illustrating one example of a function configuration of the user terminal according to the one embodiment.

FIG. 19 is a diagram illustrating one example of hardware configurations of the base station and the user terminal according to the one embodiment.

### DESCRIPTION OF EMBODIMENTS

(SRS)

According to NR, there are a wide variety of usages of Sounding Reference Signals (SRSs). The SRS of NR is used not only for CSI measurement on UL used by legacy LTE (LTE Rel. 8 to 14), but also for CSI measurement on DL and beam management.

One or a plurality of SRS resources may be configured to a UE. An SRS resource may be specified based on an SRS resource index (SRI).

Each SRS resource may include one or a plurality of SRS ports (may be associated with one or a plurality of SRS ports). For example, the number of ports per SRS may be 1, 2 or 4.

One or a plurality of SRS resource sets may be configured to the UE. One SRS resource set may relate to a given number of SRS resources. The UE may commonly use a higher layer parameter for SRS resources included in one SRS resource set. In addition, in the present disclosure, a resource set may be read as a resource group or simply as a group.

Information related to the SRS resource set and/or the SRS resources may be configured to the UE by using a higher layer signaling, a physical layer signaling or a combination of these signalings. In this regard, the higher layer signaling may be one or a combination of, for example, a Radio Resource Control (RRC) signaling, a Medium Access Control (MAC) signaling and broadcast information.

The MAC signaling may use, for example, an MAC Control Element (MAC CE) or an MAC Protocol Data Unit (PDU). The broadcast information may be, for example, a Master Information Block (MIB), a System Information Block (SIB), Remaining Minimum System information (RMSI), or Other System Information (OSI).

The physical layer signaling may be, for example, Downlink Control Information (DCI).

SRS configuration information (e.g., RRC information element “SRS-Config”) may include SRS resource set configuration information and SRS resource configuration information.

The SRS resource set configuration information (e.g., RRC parameter “SRS-ResourceSet”) may include information of SRS resource set identifiers (IDs) (SRS-ResourceSetId), a list of SRS resource IDs (SRS-ResourceId) used for the SRS resource set, an SRS resource type and an SRS usage.

In this regard, the SRS resource type may indicate one of a Periodic SRS (P-SRS), a Semi-Persistent SRS (SP-SRS) and an Aperiodic SRS (A-SRS). In addition, the UE may transmit the P-SRS and the SP-SRS periodically (or periodically after activation), and transmit the A-SRS based on an SRS request of DCI.

Furthermore, the SRS usage (an RRC parameter “usage” or a Layer-1 (L1) parameter “SRS-SetUse”) may be, for example, beam management, a codebook, a non-codebook or antenna switching. An SRS used for the codebook or the non-codebook may be used to determine a precoder of codebook-based or non-codebook-based PUSCH transmission based on an SRI.

In a case of an SRS used for beam management, it may be assumed that only one SRS resource of each SRS resource set is transmissible at a given time instant. In addition, when a plurality of SRS resources each belong to respectively different SRS resource sets, these SRS resources may be simultaneously transmitted.

The SRS resource configuration information (e.g., RRC parameter “SRS-Resource”) may include SRS resource IDs (SRS-ResourceId), the number of SRS ports, SRS port numbers, transmission Comb, SRS resource mapping (e.g., time and/or frequency resource positions, a resource offset, a resource periodicity, a repetition factor, the number of SRS symbols and an SRS bandwidth), hopping relation information, an SRS resource type, sequence IDs and spatial relation information,

The UE may transmit an SRS in neighboring symbols the number of which corresponds to the number of SRS symbols among last 6 symbols in slot. In addition, the number of SRS symbols may be 1, 2 or 4.

The UE may switch a Bandwidth Part (BWP) for transmitting an SRS per slot, or may switch an antenna. Furthermore, the UE may apply at least one of intra-slot hopping and inter-slot hopping to SRS transmission.

As transmission Comb of an SRS, Interleaved Frequency Division Multiple Access (IFDMA) that uses Comb2 (that arranges SRSs every other 2 Resource Elements (REs)) or Comb4 (that arranges SRSs every other 4 REs), and a Cyclic Shift (CS) may be applied.

The spatial relation information of the SRS (RRC parameter “spatialRelationInfo”) may indicate spatial relation information between a given reference signal and the SRS. The given reference signal may be at least one of a Synchronization Signal/Physical Broadcast Channel (SS/PBCH) block, a Channel State Information Reference Signal (CSI-RS) and an SRS (e.g., another SRS). In addition, the SS/PBCH block may be referred to as a Synchronization Signal Block (SSB).

The spatial relation information of the SRS may include at least one of an SSB index, a CSI-RS resource ID and an SRS resource ID as an index of the above given reference signal. In addition, in the present disclosure, the SSB index, the SSB resource ID and an SSB Resource indicator (SSBRI) may be interchangeably read. Furthermore, the CSI-RS index, the CSI-RS resource ID and a CSI-RS Resource Indicator (CRI) may be interchangeably read. Furthermore, the SRS index, the SRS resource ID and the SRI may be interchangeably read.

The spatial relation information of the SRS may include a serving cell index and a BWP index (BWP ID) associated with the given reference signal.

When spatial relation information related to an SSB or a CSI-RS and the SRS of a certain SRS resource is configured to the UE, the UE may transmit the certain SRS resource by using the same spatial domain filter as a spatial domain filter for receiving the SSB or the CSI-RS. That is, in this case, the UE may assume that a UE reception beam of the SSB or the CSI-RS and a UE transmission beam of the SRS are the same.

When spatial relation information related to another SRS (reference SRS) and a certain SRS (target SRS) of a certain SRS (target SRS) resource is configured to the UE, the UE may transmit the target SRS resource by using the same spatial domain filter as the spatial domain filter for transmitting the reference SRS. That is, in this case, the UE may assume that a UE transmission beam of the reference SRS and a UE transmission beam of the target SRS are the same.

In addition, the spatial domain filter for transmission from a base station, a downlink spatial domain transmission filter and a transmission beam of the base station may be interchangeably read. The spatial domain filter for reception at the base station, an uplink spatial domain receive filter and a reception beam of the base station may be interchangeably read.

Furthermore, the spatial domain filter for transmission from the UE, an uplink spatial domain transmission filter and a transmission beam of the UE may be interchangeably read. The spatial domain filter for reception at the UE, a downlink spatial domain receive filter and a reception beam of the UE may be interchangeably read.

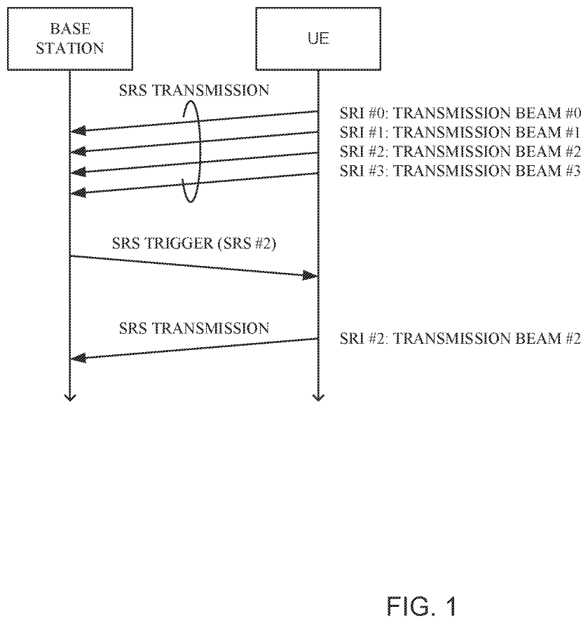

FIG. 1 is a diagram illustrating one example of beam forming control that uses SRSs. In this example, the UE is first instructed to transmit SRIs #0 to #3. The UE transmit SRSs by respectively using transmission beams #0 to #3 in association with the SRIs #0 to #3.

The base station may know in advance what kind of beams the transmission beams #0 to #3 are. The base station may measure an uplink channel (or UL CSI) based on each of the transmission beams #0 to #3.

The base station may decide that, for example, a measurement result of the transmission beam #2 (SRI #2) is the best, and then instruct the UE to perform bean transmission using the SRI #2. The UE may transmit the SRS by using the transmission beam #2 associated with the SRI #2 based on the instruction. The base station can understand what kind of a beam the UE uses in which resource (SRI).

In addition, the control in FIG. 1 may be performed irrespectively of whether or not the UE has a beam correspondence.

On the other hand, when the UE has the beam correspondence, beam forming control different from that in FIG. 1 may be applied. For example, the UE may first measure a plurality of DL RSs (DL RSs NO to #3) (e.g., CSI-RSs) by using a plurality of reception beams (e.g., reception beams #0 to #3), and then transmit the SRS by using the reception beam #2 as a transmission beam based on an SRS trigger that is based on the DL RS #2.

In addition, when the UE has the correspondence, it may be assumed that following (1) and/or (2) are satisfied: (1) The UE can determine a transmission beam of the UE for uplink transmission based on downlink measurement of the UE that uses one or more reception beams, and (2) The UE can determine a reception beam of the UE for downlink reception based on an instruction of the base station that is based on uplink measurement of the base station that uses one or more transmission beams.

Furthermore, when the base station has the correspondence, it may be assumed that following (3) and/or (4) are satisfied: (3) The base station can determine a reception beam of the base station for uplink reception based on downlink measurement of the UE that uses one or more transmission beams, and (4) The base station can determine a transmission beam of the base station for downlink transmission based on uplink measurement of the base station that uses one or more reception beams.

That is, the UE or the base station that has the beam correspondence may assume that transmission/reception beams match (or substantially match), in addition, the beam correspondence may be referred to as beam reciprocity or beam calibration or simply as a correspondence.

A beam instruction for a PUCCH may be configured by a higher layer signaling (PUCCH spatial relation information of RRC (PUCCH-Spatial-relation-info)). When, for example, the PUCCH spatial relation information includes one spatial relation information (SpatialRelationInfo) parameter, the UE may apply the configured parameter to the PUCCH. When the PUCCH spatial relation information includes two or more spatial relation information parameters, the UE may determine a parameter to be applied to the PUCCH based on an MAC CE.

A beam instruction for a PUSCH may be decided based on an SRS Resource Indicator (SRI) field included in DCI.

(UL CA)

By the way, NR assumes following scenarios regarding Carrier Aggregation (CA) on uplink.

A scenario 1-A corresponds to a case where the UE uses the same frequency range (e.g., same band) for a plurality of Component Carriers (CCs) to be subjected to CA. CA in the scenario 1-A may be referred to as intra-band CA. The scenario 1-A may assume that coverages of the respective CCs are equal and, even if base stations (that may be referred to as gNBs or Transmission/Reception Points (TRPs)) that receive transmission of the respective CCs are different, a distance between these base stations is near.

A scenario 1-B corresponds to a case where the UE uses different frequency ranges (e.g., different bands) for a plurality of CCs to be subjected to CA. CA in the scenario 1-B may be referred to as inter-band CA. The scenario 1-B may assume that coverages of the respective CCs are different and, if base stations that receive transmission of the respective CCs are different, a distance between these base stations is distant.

A scenario 2-A corresponds to a case where different base stations (in this regard, a distance between the base stations is near (the base stations are co-located)) receive transmission of the respective CCs or one base station receives transmission of the respective CCs. The scenario 2-A may assume use of intra-band CA.

A scenario 2-B corresponds to a case where different base stations (in this regard, a distance between the base stations is distant) receive transmission of the respective CCs. The scenario 2-B may assume use of inter-band CA.

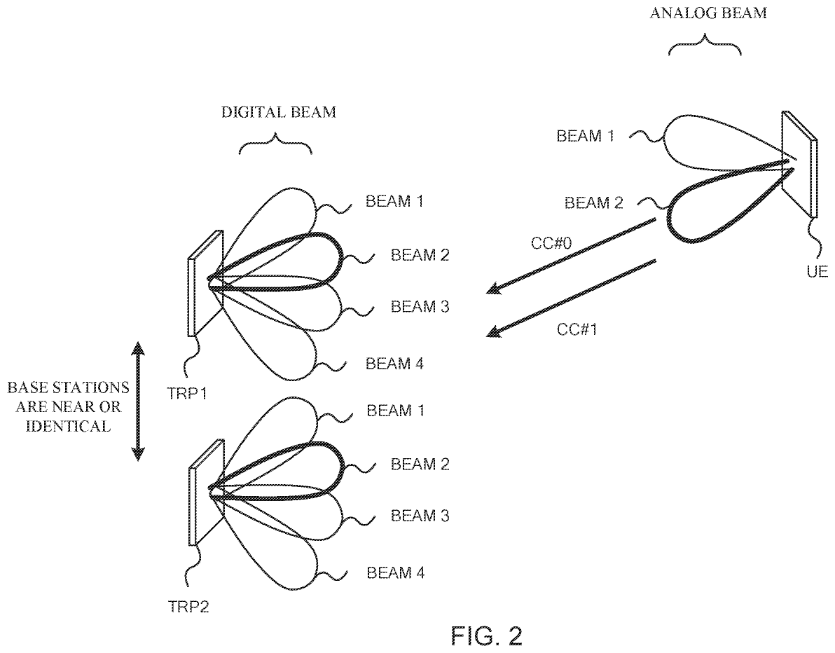

FIG. 2 is a diagram illustrating one example of beams used in the scenarios 1-A and 2-A. This example illustrates two TRPs (TRPs 1 and 2) and one UE. The UE is configured to perform CA using CCs #0 and #1, and communicates with the TRP 1 by using the CC #0, and communicates with the TRP 2 by using the CC #1.

Each TRP can simultaneously form four beams at a certain time by using digital beam forming. In a case of digital beam forming, it is possible to simultaneously form a plurality of beams.

The UE can form one of two beams at a certain time by using analog beam forming. In a case of analog beam forming, it is possible to form only one beam at a certain timing.

In this example, the TRPs 1 and 2 are configured as base stations whose distance is near or the same, so that the UE can transmit both of the CCs #0 and #1 by using the same beam 2. Each TRP may receive transmission from the UE by using each beam 2.

As illustrated in FIG. 2, in the case of the scenarios 1-A and 2-A, even when the UE uses an analog beam, it is expected that it is possible to simultaneously perform UL CA transmission in each CC.

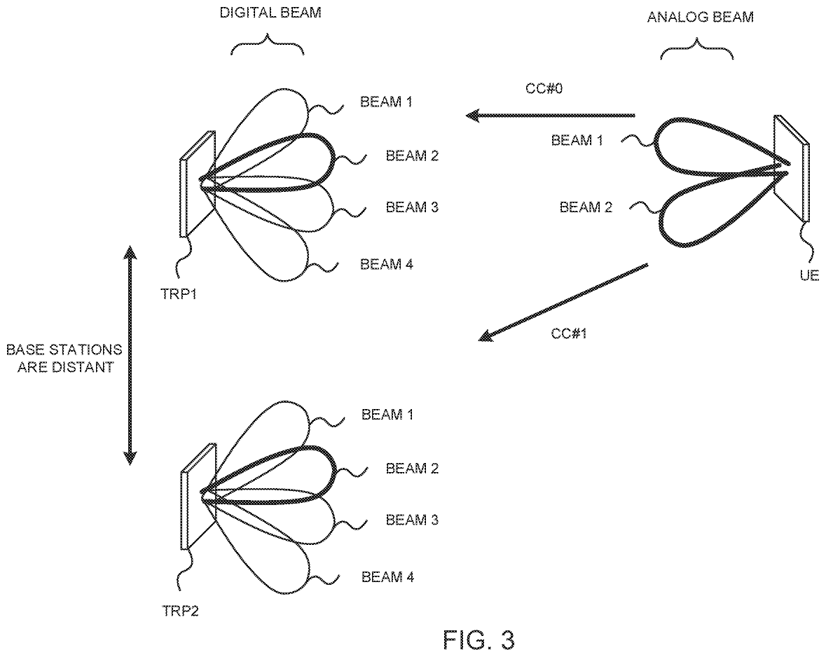

FIG. 3 is a diagram illustrating one example of beams used in the scenario 1-B and the scenario 2-B. This example is the substantially same example as that in FIG. 2, yet differs in that a distance between TRPs is distant.

In this example, the distance between the TRPs 1 and 2 is distant, and therefore it is preferred t. at the UE transmits the CCs #0 and #1 by using respectively different beams. However, when an analog beam is used, it is not possible to transmit a plurality of beams at the same timing.

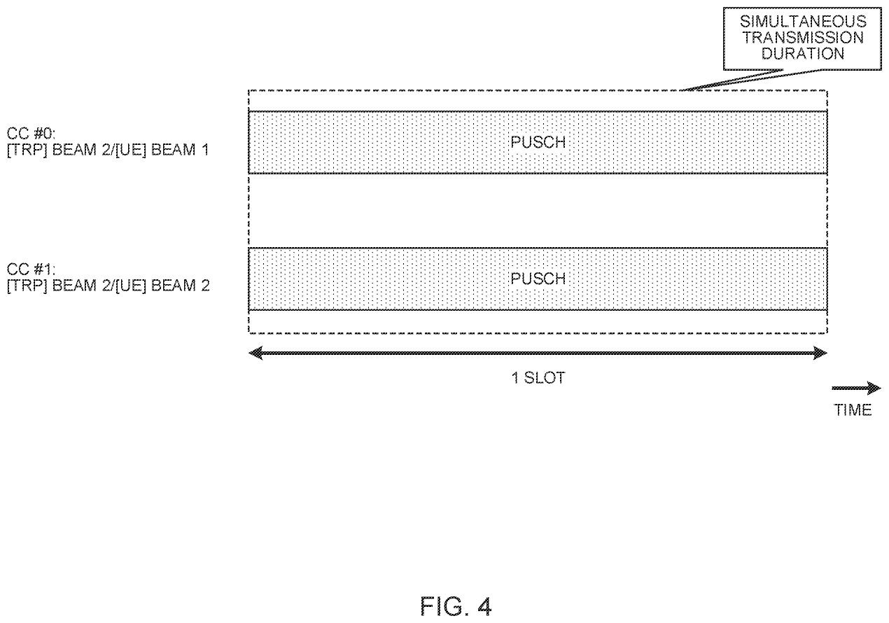

More specific description will be made with reference to FIG. 4. FIG. 4 is a diagram illustrating one example of a task of UL CA. This example illustrates that the UE transmits PUSCHs by using different beams in 2 CCs in 1 slot.

It may be assumed that TRPs (whether the TRPs are the same TRP or different TRPs is not distinguished below) receive the PUSCHs by using the beam 2 in one of the CCs #0 and #1. The UE is scheduled to transmit the PUSCHs by using the beam 1 in the CC #0, and using the beam 2 in the CC #1.

According to NR, study on which PUSCH to transmit in a case of such PUSCH and PUSCH simultaneous transmission has not yet advanced. Unless transmission is controlled according to an appropriate rule during PUSCH-PUSCH simultaneous transmission, there is a risk that there is discrepancy between the base station and the UE, and a communication throughput lowers.

Hence, the inventors of the present disclosure have conceived a UE operation that can appropriately support multiple uplink channel (e.g., PUSCH-PUSCH) simultaneous transmission.

Embodiments according to the present disclosure will be described in detail below with reference to the drawings. A radio communication method according to each embodiment may be each applied alone or may be applied in combination.

In addition, in the present disclosure, simultaneous may be read as overlapped.

Furthermore, the embodiments of the present disclosure may be applied irrespectively of which one of an analog beam and a digital beam the UE can use. By making processing integral, it is possible to expect reduction of a processing load of the UE.

(Radio Communication Method)

### First Embodiment

The first embodiment relates to an assumption during PUSCH and PUSCH simultaneous transmission. The first embodiment is roughly classified into a case (embodiment 1.1) where a UE has (or holds) a beam correspondence, and a case (embodiment 1.2) where the UE does not have the beam correspondence.

In the case where the UE has the beam correspondence, determination of a transmission beam may depend on DL beam management, and the UE may determine a transmission beam based on an SSB index or a CSI-RS index. Furthermore, in the case where the UE does not have the beam correspondence, the UE may determine a transmission beam based on an SRS resource ID.

### Embodiment 1.1

In the case where the UE has the pearl correspondence, and in a case where all SRIs indicated by respective pieces of DCI (e.g., respective pieces of DCI notified by respective CCs) for scheduling PUSCHs to be simultaneously transmitted correspond to SRS resources having a spatial relation with an SSB, the UE may make one of following assumptions:
Plus, in a case where all SSB indices associated with these SRS resources are equal transmission beams of the PUSCHs to be simultaneously transmitted are equal, and
Plus, in a case where a given number of (e.g., one) indices among the SSB indices associated with these SRS resources are different, the transmission beams of the PUSCHs to be simultaneously transmitted are different.

In the case where the UE has the beam correspondence, and in a case where SRIs indicated by respective pieces of DCI for scheduling PUSCHs to be simultaneously transmitted correspond to a first SRS resource having a spatial relation with an SSB, and a second SRS resource having a spatial relation with a CSI-RS, the UE may make one of following assumptions:
Plus, in a case where all of an SSB index associated with the first SRS resource, and an SSB index (e.g., an SSB index included in an RRC parameter “associatedSSB” configured regarding a CSI-RS index) associated with the CSI-RS index associated with the second SRS resource are equal, the transmission beams of the PUSCHs to be simultaneously transmitted are equal,
Plus, in a case where a given number of (e.g., one) indices among the SSB index associated with the first SRS resource and the SSB index associated with the CSI-RS index associated with the second SRS resource are different, the transmission beams of the PUSCHs to be simultaneously transmitted are different, and
Irrespectively of indices associated with these SRS resources, the transmission beams of the PUSCHs to be simultaneously transmitted are different.

In the case where the UE has the beam correspondence, and in a case where all SRIs indicated by respective pieces of DCI for scheduling PUSCHs to be simultaneously transmitted correspond to SRS resources having a spatial relation with a CSI-RS, the UE may make one of following assumptions:
Plus, in a case where all SSB indices associated with CSI-RS indices associated with these SRS resources are equal, transmission beams of the PUSCHs to be simultaneously transmitted are equal, and
Plus, in a case where a given number (e.g., one) indices among the SSB indices associated with the CSI-RS indices associated with these SRS resources are different, the transmission beams of the PUSCHs to be simultaneously transmitted are different.

### Embodiment 1.2

In the case where the UE does not have the beam correspondence, and in a case where all SRIs indicated by respective pieces of DCI (e.g., respective pieces of DCI notified by respective CCs) for scheduling PUSCHs to be simultaneously transmitted correspond to SRS resources having a spatial relation with a given SRS, the UE may make one of following assumptions:
Plus, in a case where all SRS resource IDs associated with these SRS resources are equal, transmission beams of the PUSCHs to be simultaneously transmitted are equal,
Plus, in a case where a given number of (e.g., one) indices among the SRS resource IDs associated with these SRS resources are different, the transmission beams of the PUSCHs to be simultaneously transmitted are different, and
Irrespectively of indices associated with these SRS resources, the transmission beams of the PUSCHs to be simultaneously transmitted are different.

In addition, the above given numbers described in embodiments 1.1 and 1.2 may be configured by a higher layer signaling, or may be specified by a specification.

According to the above-described first embodiment, it is possible to appropriately decide beams to be applied to PUSCHs when these PUSCH and PUSCH are simultaneously transmitted.

### Second Embodiment

The second embodiment relates to control in a case where transmission beams of respective PUSCHs are different during PUSCH-PUSCH simultaneous transmission. When transmission beams of PUSCHs that are simultaneously transmitted (overlap) are different, a UE may determine the PUSCHs to be transmitted at respective timings.

The UE may determine the PUSCHs to be transmitted in a PUSCH-PUSCH simultaneous transmission duration based on given conditions. For example, the UE may determine to transmit PUSCHs corresponding to one of following (1) to (4) in the PUSCH-PUSCH simultaneous transmission duration:

### (1) A PUSCH of a Primary Cell (PCell),

(2) A PUSCH of a CC of a smaller CC index (or a serving cell index or a Secondary Cell (SCell) index),
(3) A PUSCH scheduled by a PDCCH (DCI) detected in a COntrol REsource SET (CORESET) (or a search space associated with a smaller search space ID) associated with a smaller CORESET ID, and
(4) A PUSCH scheduled by a PDCCH (DCI) detected in a common search space.

In a case of a PUSCH that corresponds to a given Quasi-Co-Location (QCL) relation (e.g., below-described QCL type D) or a given spatial relation (e.g., the PUSCH has a spatial relation based on the same RS index) with a PUSCH whose transmission has been determined to be performed, the UE may simultaneously transmit the PUSCHs.

QCL will be briefly described. It is studied for NR that the UE controls reception processing (e.g., demapping, demodulation, decoding and reception beam formation) and transmission processing (e.g., mapping, modulation, encoding, precoding and transmission beam formation) of a channel (e.g., a PDCCH, a PDSCH or a PUCCH) based on information (QCL information) related to QCL of the channel.

The QCL is an index that indicates a statistical property of a channel. When, for example, a certain signal/channel and another signal/channel have a QCL relation, the QCL relation may mean that it is possible to assume that at least one of a doppler shift, a doppler spread, an average delay, a delay spread and a spatial parameter (e.g., spatial reception parameter (spatial Rx parameter)) is identical (the QCL holds for at least one of these parameters) between a plurality of these different signals/channels.

In addition, the spatial reception parameter may be associated with a beam (e.g., analog beam) of the UE, and a beam may be specified based on spatial QCL. The QCL (or at least one element of the QCL) in the present disclosure may be read as spatial QCL (sQCL).

A plurality of types of QCL (QCL types) may be specified. For example, four QCL types A to D whose parameters (or parameter sets) that can be assumed identical are different may be provided, and the parameters are as follows:
QCL type A: doppler shift, doppler spread, average delay and delay spread,
QCL type B: doppler shift and doppler spread,
QCL type C: average delay and doppler shift, and
QCL type D: spatial reception parameter.

The UE may transmit a PUSCH whose transmission has been determined not to be performed in the PUSCH-PUSCH simultaneous transmission duration (e.g., a PUSCH that does not correspond to above (1) to (4) and does not correspond to the given QCL relation with a PUSCH to be transmitted) in the rest of a duration other than the simultaneous transmission duration. That is, the UE may completely drop the PUSCH whose transmission has been determined not to be performed in the PUSCH-PUSCH simultaneous transmission duration, or may transmit part of the PUSCH.

When the numbers of PUSCH symbols of respective transmission beams are different, and PUSCH transmission start timings are also different, and when the number of symbols of a PUSCH (also referred to as a “priority PUSCH” below for ease of description) to be transmitted in the simultaneous transmission duration is smaller than the number of symbols of the PUSCH (also referred to as a “non-priority PUSCH” below for ease of description) that is not transmitted in the simultaneous transmission duration, the UE may assume that symbols in the simultaneous transmission duration among symbols of the non-priority PUSCH are punctured or rate-matched, and transmit the rest of symbols. That is, the non-priority PUSCH and the priority PUSCH may be transmitted by switching two transmission beams.

In this regard, puncture processing of the PUSCH may mean performing encoding assuming that resources allocated for the PUSCH can be used (or without taking an unavailable resource amount into account), yet not mapping encoded symbols on resources that cannot be actually used (i.e., keeping resources unused). By not using the encoded symbols of the punctured resources for decoding on a reception side, it is possible to suppress deterioration of characteristics due to the puncturing.

Furthermore, the rate-matching processing of the PUSCH refers to controlling the number of bits after encoding (encoded bits) by taking actually available radio resources into account. When the number of encoded bits is smaller than the number of bits that can be mapped on the actually available radio resources, at least part of the encoded bits may be repeated. When the number of encoded bits is larger than the number of bits that can be mapped, part of the encoded bits may be deleted.

When the numbers of PUSCH symbols of respective transmission beams are different, and the PUSCH transmission start timings are also different, and when the number of symbols of the priority PUSCH is smaller than the number of symbols of the non-priority PUSCH, the UE may assume that the non-priority PUSCH is not transmitted.

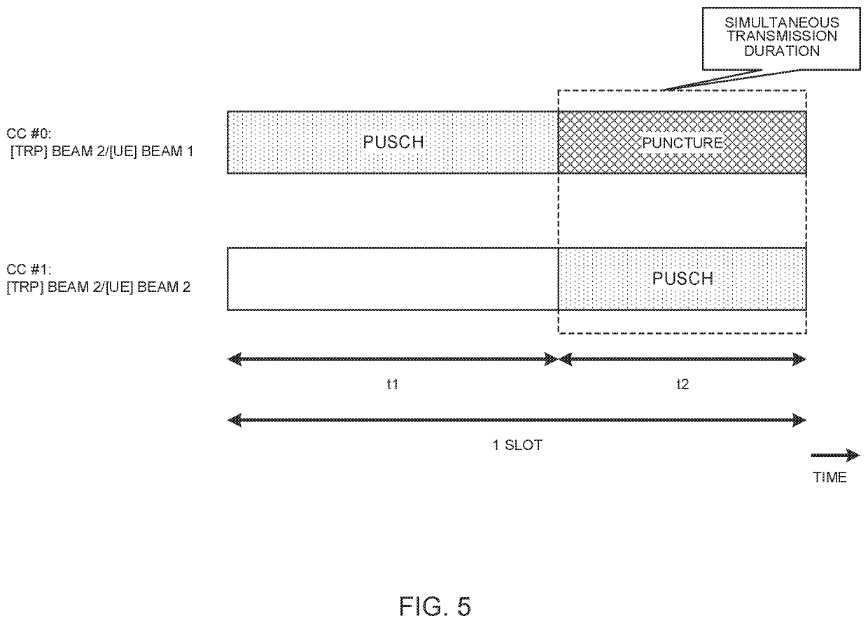

FIG. 5 is a diagram illustrating one example of PUSCH transmission in a case where the numbers of PUSCH symbols of transmission beams of respective CCs are different, and PUSCH transmission start timings are also different.

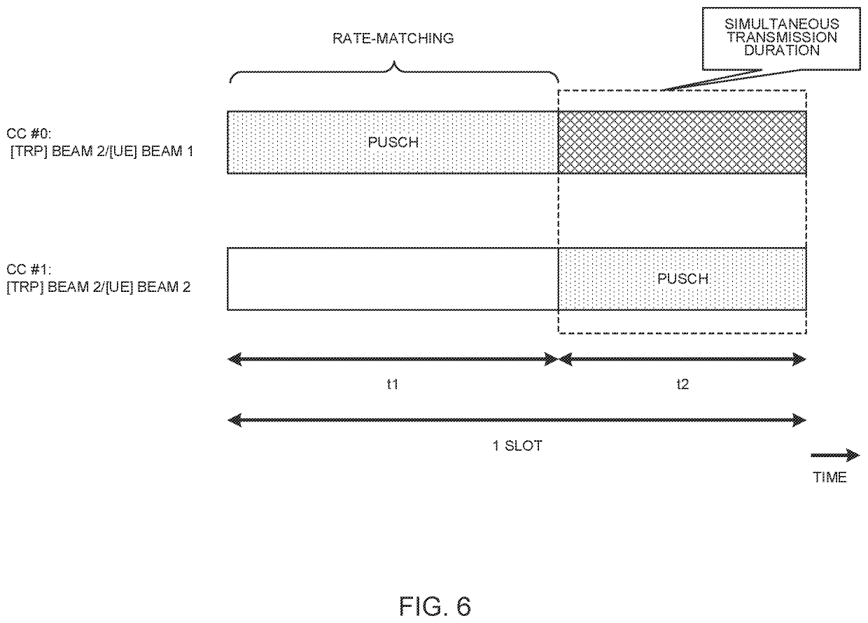

In this example, the UE is instructed (or configured) to simultaneously transmit a PUSCH of a CC #0 and a PUSCH of a CC #1 in a certain slot. It is assumed that the UE performs transmission by using a beam 1 in the CC #0 and performs transmission by using a beam 2 in the CC #1. It is assumed that a TRP (e.g., base station) performs reception by using the beam 2. The assumption on the beams applies likewise to followings FIGS. 6 to 10.

In this example, a time resource of the PUSCH of the CC #0 is entire 1 slot, and a time resource of the PUSCH of the CC #1 is a duration t2 in FIG. 5. The UE does not perform transmission in a duration t1 of the CC #1. Hence, a transmission start timing of the PUSCH of the CC #0 is earlier than that of the PUSCH of the CC #1.

The UE determines that the PUSCH of the CC #1 among the PUSCHs to be simultaneously transmitted is the priority PUSCH based on the given conditions (e.g., above-described (1) to (4)). That is, the UE uses the beam #2 to transmit the PUSCH of the CC #1 in the simultaneous transmission duration (t2), and does not transmit the PUSCH of the CC #0 that uses the beam #1.

The UE punctures the PUSCH (non-priority PUSCH) of the CC #0 in the duration t2, and transmits the PUSCH of the CC #0 in the rest of the duration t1 by using the beam #1. By so doing, the UE can transmit the PUSCHs by switching the beams #1 and #2.

FIG. 6 is a diagram illustrating another example of PUSCH transmission in a case where the numbers of PUSCH symbols of transmission beams of respective CCs are different, and the PUSCH transmission start timings are also different.

This example is the substantially same example as that in FIG. 5, yet differs in that the UE applies rate-matching processing instead of puncturing to the PUSCH of the CC #0.

The UE applies rate-matching to the PUSCH of the CC #0 in the duration t1 by taking into account that the PUSCH of the CC #0 cannot be transmitted in the duration t2, and transmits the PUSCH of the CC #0 in the duration t1 by using the beam #1.

Furthermore, when the numbers of PUSCH symbols of respective transmission beams are different, and PUSCH transmission start timings are the same, and when the number of symbols of the priority PUSCH is smaller than the number of symbols of the non-priority PUSCH, the UE may assume that symbols in the simultaneous transmission duration among symbols of the non-priority PUSCH are punctured or rate-matched, and transmit the rest of symbols. That is, the UE may transmit the non-priority PUSCH and the priority PUSCH by switching two transmission beams.

When the numbers of PUSCH symbols of respective transmission beams are different, and the PUSCH transmission start timings are the same, and when the number of symbols of the priority PUSCH is smaller than the number of symbols of the non-priority PUSCH, the UE may assume that the non-priority PUSCH is not transmitted.

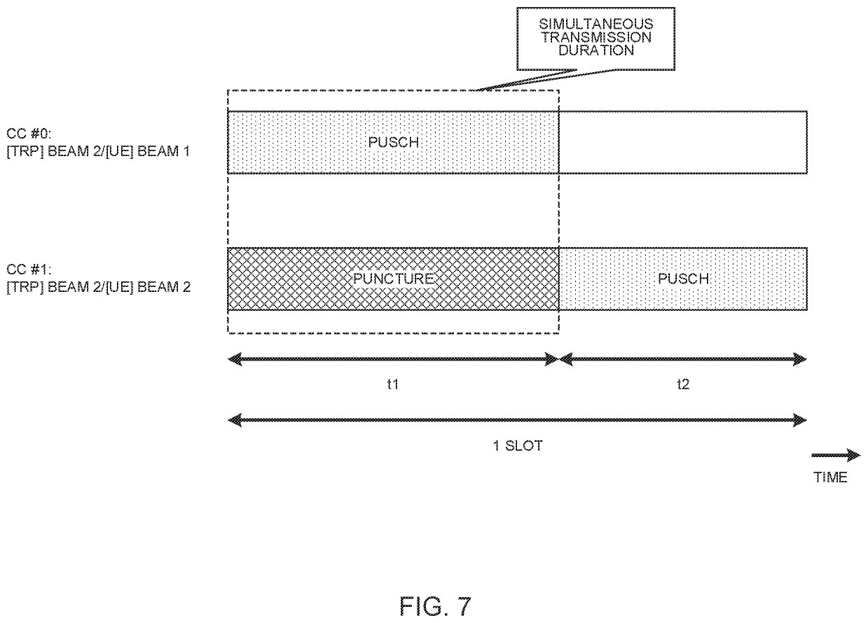

FIG. 7 is a diagram illustrating one example of PUSCH transmission in a case where the numbers of PUSCH symbols of transmission beams of respective CCs are different, and PUSCH transmission start timings are the same.

In this example, a time resource of the PUSCH of the CC #0 is the duration t1, and a time resource of the PUSCH of the CC #1 is entire 1 slot. The UE does not perform transmission in the duration t2 of the CC #0. Hence, the transmission start timings of the PUSCH of the CC #0 and the PUSCH of the CC #1 are equal.

The UE determines that the PUSCH of the CC #0 among the PUSCHs to be simultaneously transmitted is the priority PUSCH based on the given conditions (e.g., above-described (1) to (4)). That is, the UE uses the beam #1 to transmit the PUSCH of the CC #9 in the simultaneous transmission duration (t1), and does not transmit the PUSCH of the CC #1 that uses the beam #2.

The UE punctures the PUSCH (non-priority PUSCH) of the CC #1 in the duration t1, and transmits the PUSCH of the CC #1 in the rest of the duration t2 by using the beam #2. By so doing, the UE can transmit the PUSCHs by switching the beams #1 and #2.

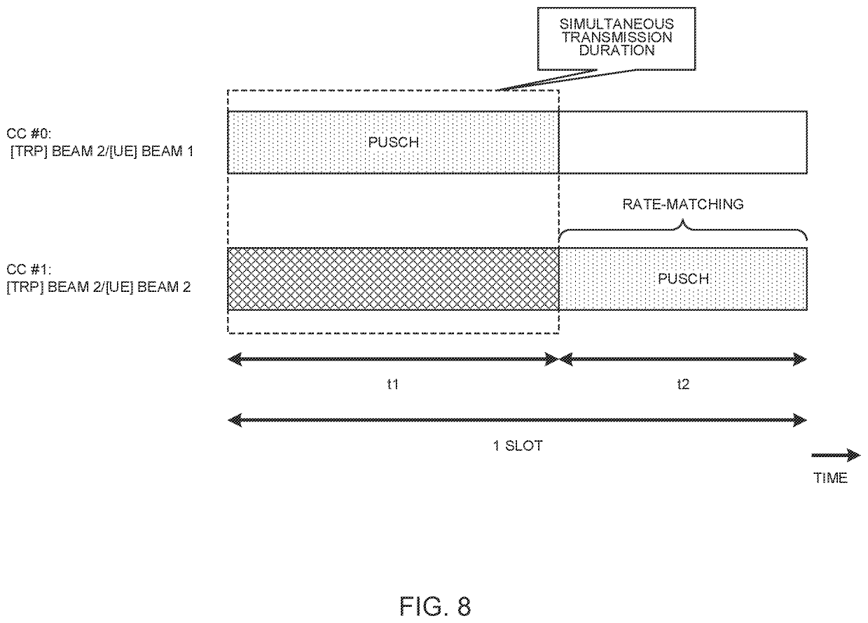

FIG. 8 is a diagram illustrating another example of PUSCH transmission in a case where the numbers of PUSCH symbols of transmission beams of respective CCs are different, and the PUSCH transmission start timings are the same.

This example is the substantially same example as that in FIG. 7, yet differs in that the UE applies rate-matching processing instead of puncturing to the PUSCH of the CC #1.

The UE applies rate-matching to the PUSCH of the CC #1 in the duration t2 by taking into account that the PUSCH of the CC #1 cannot be transmitted in the duration t1, and transmits the PUSCH of the CC #1 in the duration t2 by using the beam #2.

In addition, the UE may assume that, even when the number of symbols of the priority PUSCH is smaller than the number of symbols of the non-priority PUSCH, and when the number of the rest of symbols except symbols in the simultaneous transmission duration among symbols of the non-priority PUSCH is a given value or more, the UE transmits the rest of symbols, and, when the number of the rest of symbols is not the given value or more, the UE does not transmit the rest of symbols.

Furthermore, when the number of symbols of the priority PUSCH is the same as or larger than the number of symbols of the non-priority PUSCH, the UE may not transmit the non-priority PUSCH at all. Furthermore, when the number of symbols of the priority PUSCH is the same as, smaller than or larger than the number of symbols of the non-priority PUSCH, the UE may not transmit part of the symbols of the priority PUSCH, and may perform control to transmit the non-priority PUSCH in this duration in which the part of the symbols of the priority PUSCH are not transmitted.

The examples in FIGS. 5 to 8 have described that delay does not occur (can be ignored) accompanying switching of a transmission beam, yet the delay may be taken into account. When the number of PUSCH symbols of respective transmission beams are different, and when part of symbols of the non-priority PUSCH are also transmitted as described above, the UE may ignore (e.g., may not transmit) one or a plurality of part of symbols of the non-priority PUSCH.

The UE may assume that the UE performs processing of switching transmission beams in the symbols to be ignored. The symbols to be ignored may be referred to as a gap for beam switching. The symbols to be ignored are preferably before or after the simultaneous transmission duration.

In this regard, the number of symbols to be ignored may be configured (instructed) by a higher layer signaling (e.g., RRC signaling), a physical layer signaling (e.g., DCI) or a combination of these signalings, may be specified by a specification or may depend on an implementation of the UE.

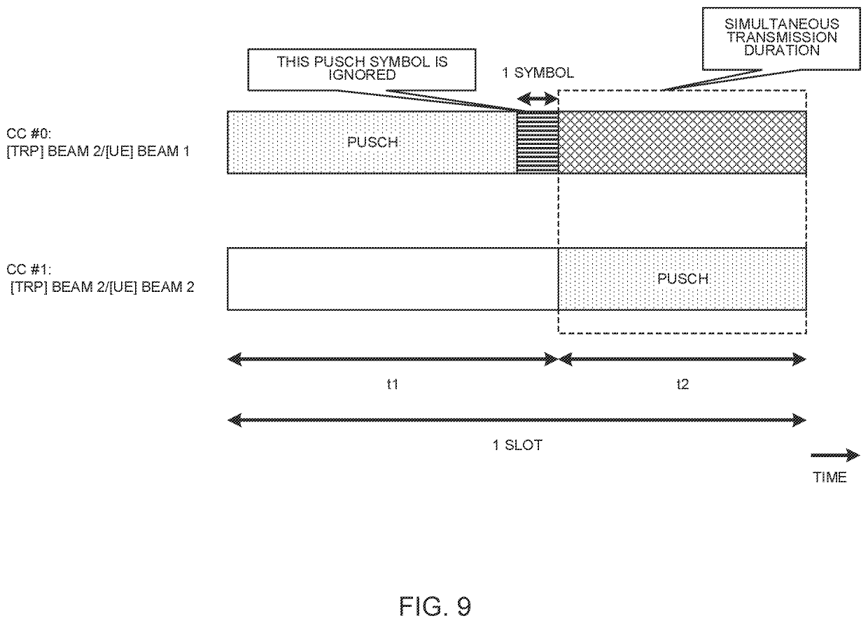

FIG. 9 is a diagram illustrating still another example of PUSCH transmission in a case where the number of PUSCH symbols of transmission beams of respective CCs are different, and PUSCH transmission start timings are also different.

This example is the substantially same example as that in FIG. 5, yet differs in that the PUSCH (non-priority PUSCH) of the CC #0 that is 1 symbol before the simultaneous transmission duration is ignored.

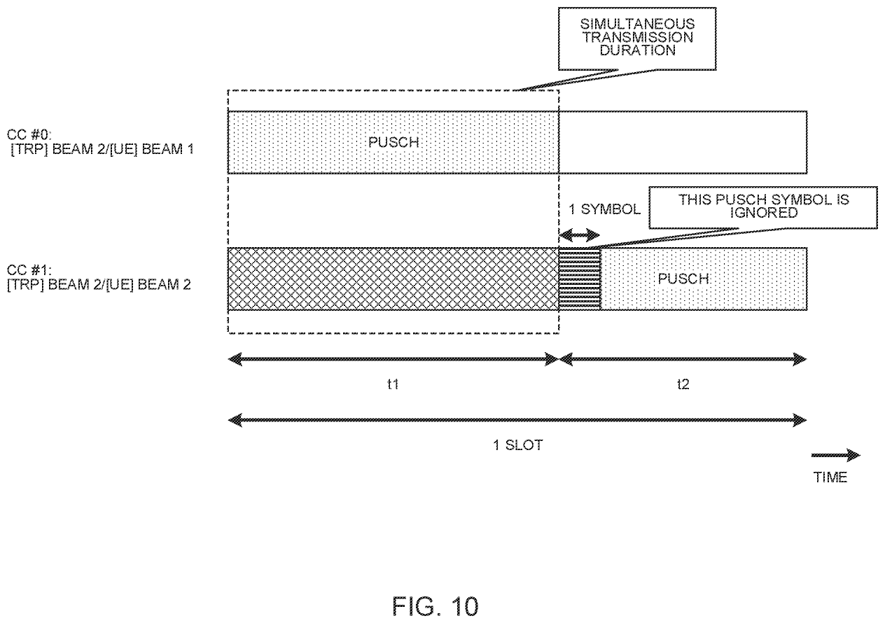

FIG. 10 is a diagram illustrating still another example of PUSCH transmission in a case where the number of PUSCH symbols of transmission beams of respective CCs are different, and PUSCH transmission start timings are the same.

This example is the substantially same example as that in FIG. 7, yet differs in that the PUSCH (non-priority PUSCH) of the CC #1 that is 1 symbol after the simultaneous transmission duration is ignored.

According to the above-described second embodiment, it is possible to appropriately determine PUSCHs to be transmitted when these PUSCH and PUSCH are simultaneously transmitted.

### Third Embodiment

Similar to the second embodiment, the third embodiment also relates to control in a case where transmission beams of respective PUSCHs are different during PUSCH-PUSCH simultaneous transmission. When a UE has capability for simultaneously transmitting PUSCHs by using respectively different transmission beams, the UE may simultaneously transmit these PUSCHs in the same slot. (or symbol).

The UE may transmit information of the number of transmission beams that can be simultaneously transmitted (and that may be expressed as the number of PUSCHs that can be simultaneously transmitted or the number of different transmission beams that can be simultaneously transmitted) as UE capability information to a base station. The base station may control scheduling by taking the information into account.

The UE may simultaneously transmit arbitrary PUSCHs irrespectively of a QCL relation of the PUSCHs when the number of transmission beams is equal to or less than the number of transmission beams that can be simultaneously transmitted.

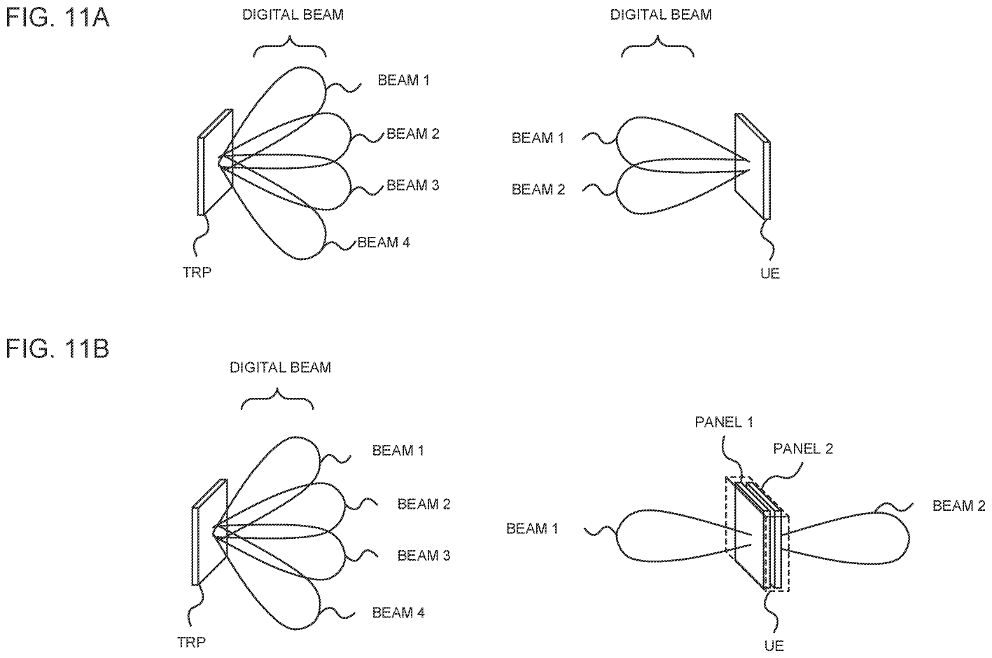

FIGS. 11A and 11B are diagrams illustrating one example of a situation assumed in the third embodiment. FIG. 11A illustrates an example where the UE can use digital beam forming. The UE can simultaneously form beams 1 and 2.

FIG. 11B illustrates an example where the UE performs transmission by using a plurality of antenna panels (panels 1 and 2). When, for example, one beam is formed for 1 panel, and even when the respective beams are analog beams, the UE can simultaneously form the beams 1 and 2.

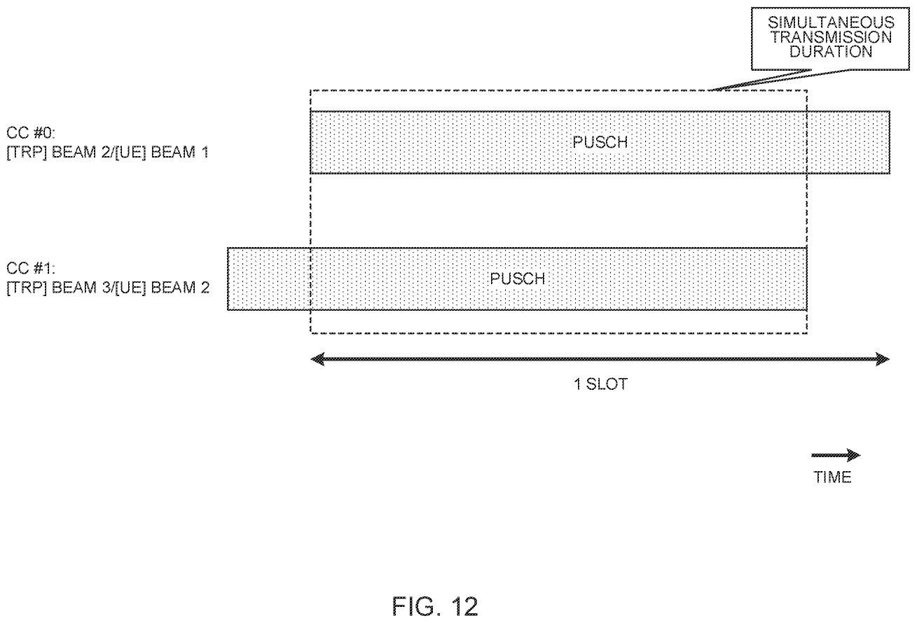

FIG. 12 is a diagram illustrating one example of PUSCH transmission according to the third embodiment. In this example, the UE is instructed (or configured) to transmit a PUSCH of a CC #0 and a PUSCH of a CC #1 in an overlapping manner.

It is assumed that the UE performs transmission by using the beam 1 in the CC #0, and performs transmission by using the beam 2 in the CC #1. It is assumed that a TRP performs reception by using the beam 2 in the CC #0, and performs reception by using a beam 3 in the CC #1.

When the UE has capability that makes it possible to simultaneously transmit two or more different beams, the UE can simultaneously transmit the PUSCH of the CC #0 by using the beam 1 and the PUSCH of the CC #1 by using the beam 2 during the simultaneous transmission duration, too.

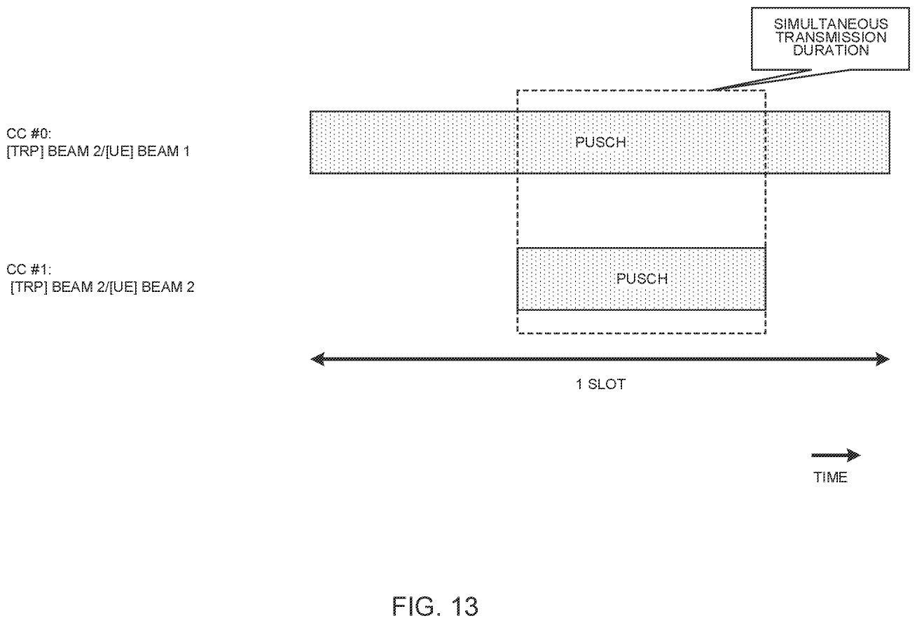

FIG. 13 is a diagram illustrating another example of PUSCH transmission according to the third embodiment. In this example, too, the UE is instructed (or configured) to transmit the PUSCH of the CC #0 and the PUSCH of the CC #1 in an overlapping manner. In addition, PUSCH symbols of the CC #1 are included in PUSCH symbols of the CC #2.

It is assumed that the UE performs transmission by using the beam 1 in the CC #0, and performs transmission by using the beam 2 in the CC #1. It is assumed that the TRP performs reception by respectively using the beam 2 in both of the CCs #0 and #1.

When the UE has capability that makes it possible to simultaneously transmit two or more different beams, the UE can simultaneously transmit the PUSCH of the CC #0 by using the beam 1 and the PUSCH of the CC #1 by using the beam 2 during the simultaneous transmission duration too.

According to the above-described third embodiment, it is possible to simultaneously transmit a PUSCH and a PUSCH.

### Modified Example 1

In each embodiment, whether or not to apply PUSCH-PUSCH simultaneous transmission may be decided based on an SRI index (an SRI index associated with a PUSCH) instructed by DCI for scheduling the PUSCH. For example, a UE that has been instructed (or scheduled) to simultaneously transmit PUSCHs in a plurality of CCs may decide whether or not transmission beams (Tx beams) of respective PUSCHs are identical based on whether or not there is a beam correspondence and the SRI index, and control simultaneous transmission of PUSCHs.

A case is assumed where the UE that has reported that the UE has had the beam correspondence is instructed to simultaneously transmit the PUSCHs in a plurality of CCs. In this case, the UE may decide whether or not the transmission beams of the respective PUSCHs are identical based on a quasi-co-location relation between RSs indicated by SRI indices associated with the respective PUSCHs.

When the RSs indicated by the SRI indices associated with the respective PUSCHs are in given quasi-co-location (that is, for example, QCL-TypeD), the UE simultaneously transmit the PUSCHs assuming that the transmission beams of the respective PUSCHs are identical. On the other hand, when the RSs indicated by the SRI indices associated with the respective PUSCHs are not in the given quasi-co-location (that is, for example, other than CCL-TypeD), the UE may perform control not to simultaneously transmit the PUSCHs assuming that the transmission beams of the respective PUSCHs are different.

Next, a case is assumed where the UE that has reported that the UE has not had the beam correspondence is instructed to simultaneously transmit PUSCHs in a plurality of CCs. In this case, the UE may decide whether or not the transmission beams of the respective PUSCHs are identical based on SRI indices associated with the respective PUSCHs.

When, for example, the SRI indices associated with the respective PUSCHs are the same, the UE simultaneously transmits the PUSCHs assuming that the transmission beams of the respective PUSCHs are identical. On the other hand, when the SRI indices associated with the respective PUSCHs are different, the UE may perform control not to simultaneously transmit the PUSCHs assuming that the transmission beams of the respective PUSCHs are different.

Furthermore, when the UE that has reported that the UE has not had the beam correspondence is instructed to simultaneously perform UL transmission in a plurality of CCs, the UE may control UL simultaneous transmission assuming that an association between SRI indices and transmission beams (Tx beams) of the UE are the same in respective CCs, That is, when being notified of the same SRI index in the different CCs, the UE may assume that the transmission beams (or resources) applied to UL transmission of the respective CCs are the same. UL transmission may be at least one of a PUSCH, a PUCCH and an SRS.

Consequently, when UL transmission (e.g., at least one of the PUSCH, the PUCCH and the SRS) is simultaneously instructed in different CCs, it is possible to decide whether or not simultaneous transmission is performed based on SRI indices.

### Modified Example 2

Each embodiment has described assuming PUSCH-PUSCH simultaneous transmission. However, signals and channels to be simultaneously transmitted are not limited to a combination of these. The PUSCH in each embodiment or modified example 1 may be read as at least one of a PUCCH, a PUSCH, an SRS and a DeModulation Reference Signal (DMRS). For example, determination of beams and determination of signals/channels to transmit that are applied based on description of each embodiment can be performed for PUCCH-PUCCH simultaneous transmission and PUCCH-PUSCH simultaneous transmission (e.g., in a case of a UE that has capability for performing PUCCH-PUSCH simultaneous transmission).

Furthermore, each embodiment has been described assuming that PUSCH-PUSCH simultaneous transmission is performed in different CCs, yet is not limited to this. Respective PUSCHs may be transmitted in respectively different specific control units. The control unit may be one or a combination of a CC, a CC group, a cell group, a PUCCH group, an MAC entity, a Frequency Range (FR), a band and a BWP. The above control unit may be referred to simply as a group.

(Radio Communication System)

The configuration of the radio communication system according to one embodiment of the present disclosure will be described below. This radio communication system uses one or a combination of the radio communication method according to each of the above embodiments of the present disclosure to perform communication.

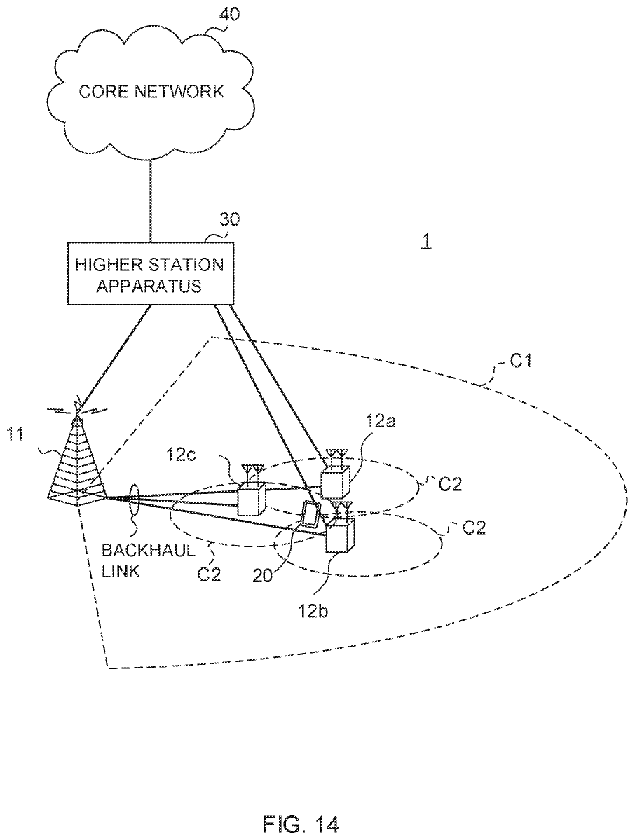

FIG. 14 is a diagram illustrating one example of a schematic configuration of the radio communication system according to the one embodiment. A radio communication system 1 can apply at least one of Carrier Aggregation (CA) and Dual Connectivity (DC) that aggregate a plurality of base frequency blocks (component carriers) whose 1 unit is a system bandwidth (e.g., 20 MHz).

In this regard, the radio communication system 1 may be referred to as Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), New Radio (NR), Future Radio Access (FRA) and the New Radio Access Technology (New-RAT), or a system that realizes these techniques.

Furthermore, the radio communication system 1 may support dual connectivity between a plurality of Radio Access Technologies (RATs) (Multi-RAT Dual Connectivity (MR-DC)). MR-DC may include, for example, dual connectivity of LTE and NR (EN-DC: E-UTRA-NR Dual Connectivity) where a base station (eNB) of LTE (E-UTRA) is a Master Node (MN), and a base station (gNB) of NR is a Secondary Node (SN), and dual connectivity of NR and LTE (NE-DC: NR-E-UTRA Dual Connectivity) where a base station (gNB) of NR is an MN, and a base station (eNB) of LTE (E-UTRA) is an SN.

The radio communication system 1 includes a base station 11 that forms a macro cell C1 of a relatively wide coverage, and base stations 12 (12a to 12c) that are located in the macro cell C1 and form small cells C2 narrower than the macro cell C1. Furthermore, a user terminal 20 is located in the macro cell C1 and each small cell C2. An arrangement and the numbers of respective cells and the user terminals 20 are not limited to the aspect illustrated in FIG. 14.

The user terminal 20 can connect with both of the base station 11 and the base stations 12. The user terminal 20 is assumed to simultaneously use the macro cell C1 and the small cells C2 by using CA or DC. Furthermore, the user terminal 20 can apply CA or DC by using a plurality of cells (CCs).

The user terminal 20 and the base station 11 can communicate by using a carrier (also referred to as a legacy carrier) of a narrow bandwidth in a relatively low frequency band (e.g., 2 GHz). On the other hand, the user terminal 20 and each base station 12 may use a carrier of a wide bandwidth in a relatively high frequency band (e.g., 3.5 GHz or 5 GHz) or may use the same carrier as that used between the user terminal 20 and the base station 11. In this regard, a configuration of the frequency band used by each base station is not limited to this.

Furthermore, the user terminal 20 can perform communication by using at least one of Time Division Duplex (TDD) and Frequency Division Duplex (FDD) in each cell. Furthermore, each cell (carrier) may be applied a single numerology or may be applied a plurality of different numerologies.

The numerology may be a communication parameter to be applied to at least one of transmission and reception of a certain signal or channel, and may indicate at least one of, for example, a subcarrier spacing, a bandwidth, a symbol length, a cyclic prefix length, a subframe length, a TTI length, the number of symbols per TTI, a radio frame configuration, specific filtering processing performed by a transceiver in a frequency domain, and specific windowing processing performed by the transceiver in a time domain.

For example, a case where at least ones of subcarrier spacings of constituent OFDM symbols and the numbers of OFDM symbols are different on a certain physical channel may be read as that numerologies are different.

The base station 11 and each base station 12 (or the two base stations 12) may be connected by way of wired connection (e.g., optical fibers compliant with a Common Public Radio Interface (CPRI) or an X2 interface) or radio connection.

The base station 11 and each base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each base station 12 may be connected with the higher station apparatus 30 via the base station 11.

In this regard, the base station 11 is a base station that has a relatively wide coverage, and may be referred to as a macro base station, an aggregate node, an eNodeB (eNB) or a transmission/reception point. Furthermore, each base station 12 is a base station that has a local coverage, and may be referred to as a small base station, a micro base station, a pico base station, a femto base station, a Home eNodeB (HeNB), a Remote Radio Head (RRH) or a transmission/reception point. The base stations 11 and 12 will be collectively referred to as a base station 10 below when not distinguished.

Each user terminal 20 is a terminal that supports various communication schemes such as LTE, LTE-A and 5G, and may include not only a mobile communication terminal (mobile station) but also a fixed communication terminal (fixed station).

The radio communication system 1 applies Orthogonal Frequency-Division Multiple Access (OFDMA) to downlink and applies at least one of Single Carrier-Frequency Division Multiple Access (SC-FDMA) and OFDMA to uplink as radio access schemes.

OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these schemes, and other radio access schemes may be used.

The radio communication system 1 uses a downlink shared channel (PDSCH: Physical Downlink Shared Channel) shared by each user terminal 20, a broadcast channel (PBCH: Physical Broadcast Channel) and a downlink control channel as downlink channels, User data, higher layer control information and a System Information Block (SIB) are conveyed on the PDSCH. Furthermore, a Master Information Block (MIB) is conveyed on the PBCH.

The downlink control channel includes a Physical Downlink Control Channel (PDCCH), an Enhanced Physical Downlink Control Channel (EPDCCH)), a Physical Control Format indicator Channel (PHICH), and a Physical Hybrid-ARQ Indicator Channel (PHICH). Downlink Control Information (DCI) including scheduling information of at least one of the PDSCH and the PUSCH is conveyed on the PDCCH.

For example, DCI for scheduling DL data reception may be referred to as a DL assignment, and DCI for scheduling UL data transmission may be referred to as a UL grant.

The number of OFDM symbols used for the PDCCH may be conveyed on the PCFICH. Transmission acknowledgement information (also referred to as, for example, retransmission control information, HARQ-ACK or ACK/NACK) of a Hybrid Automatic Repeat reQuest (HARQ) for the PUSCH may be conveyed on the PHICH. The EPDCCH is subjected to frequency division multiplexing with the PDSCH (downlink shared data channel) and is used to convey DCI similar to the PDCCH.

The radio communication system 1 uses an uplink shared channel (PUSCH: Physical Uplink Shared Channel) shared by each user terminal 20, an uplink control channel (PUCCH: Physical Uplink Control Channel), and a random access channel (PRACH: Physical Random Access Channel) as uplink channels. User data and higher layer control information are conveyed on the PUSCH. Furthermore, downlink radio quality information (CQI: Channel Quality Indicator), transmission acknowledgement information and a Scheduling Request (SR) are conveyed on the PUCCH. A random access preamble for establishing connection with a cell is conveyed on the PRACH.

The radio communication system 1 conveys a Cell-specific Reference Signal (CRS), a Channel State Information-Reference Signal (CSI-RS), a DeModulation Reference Signal (DMRS) and a Positioning Reference Signal (PRS) as downlink reference signals. Furthermore, the radio communication system 1 conveys a Sounding Reference Signal (SRS) and a DeModulation Reference Signal (DMRS) as uplink reference signals. In this regard, the DMRS may be referred to as a user terminal-specific reference signal (UE-specific reference signal). Furthermore, a reference signal to be conveyed is not limited to these.

(Base Station)

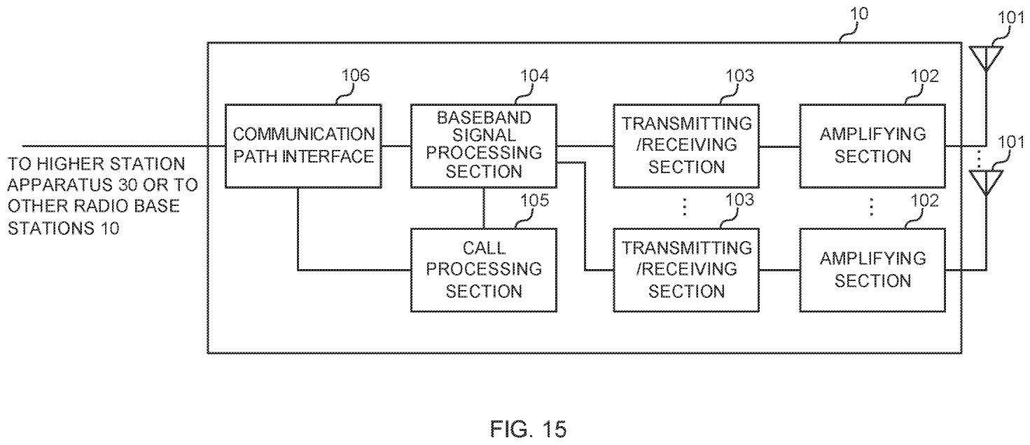

FIG. 15 is a diagram illustrating one example of an overall configuration of the base station according to the one embodiment. The base station 10 includes pluralities of transmission/reception antennas 101, amplifying sections 102 and transmitting/receiving sections 103, a baseband signal processing section 104, a call processing section 105 and a communication path interface 106. In this regard, the base station 10 only needs to be configured to include one or more of each of the transmission/reception antennas 101, the amplifying sections 102 and the transmitting/receiving sections 103.

User data transmitted from the base station 10 to the user terminal 20 on downlink is input from the higher station apparatus 30 to the baseband signal processing section 104 via the communication path interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the user data, and transfers the user data to each transmitting/receiving section 103. Furthermore, the baseband signal processing section 104 performs transmission processing such as channel coding and inverse fast Fourier transform on a downlink control signal, too, and transfers the downlink control signal to each transmitting/receiving section 103.

Each transmitting/receiving section 103 converts a baseband signal precoded and output per antenna from the baseband signal processing section 104 into a radio frequency range, and transmits a radio frequency signal. The radio frequency signal subjected to frequency conversion by each transmitting/receiving section 103 is amplified by each amplifying section 102, and is transmitted from each transmission/reception antenna 101. The transmitting/receiving sections 103 can be composed of transmitters/receivers, transmission/reception circuits or transmission/reception apparatuses described based on a common knowledge in a technical field according to the present disclosure. In this regard, the transmitting/receiving sections 103 may be composed as an integrated transmitting/receiving section or may be composed of transmitting sections and reception sections.

Meanwhile, each amplifying section 102 amplifies a radio frequency signal received by each transmission/reception antenna 101 as an uplink signal. Each transmitting/receiving section 103 receives the uplink signal amplified by each amplifying section 102, Each transmitting/receiving section 103 performs frequency conversion on the received signal into a baseband signal, and outputs the baseband signal to the baseband signal processing section 104.

The baseband signal processing section 104 performs Fast Fourier Transform (FFT) processing, inverse Discrete Fourier Transform (IDFT) processing, error correcting decoding, MAC retransmission control reception processing, and reception processing of an RLC layer and a PDCP layer on user data included in the input uplink signal, and transfers the user data to the higher station apparatus 30 via the communication path interface 106. The call processing section 105 performs call processing (such as configuration and release) of a communication channel, state management of the base station 10 and radio resource management.

The communication path interface 106 transmits and receives signals to and from the higher station apparatus 30 via a given interface. Furthermore, the communication path interface 106 may transmit and receive (backhaul signaling) signals to and from the another base station 10 via an inter-base station interface (e.g., optical fibers compliant with the Common Public Radio Interface (CPRI) or the X2 interface).

In addition, each transmitting/receiving section 103 may further include an analog beam forming section that performs analog beam forming. The analog beam forming section can be composed of an analog beam forming circuit (e.g., a phase shifter or a phase shift circuit) or an analog beam forming apparatus (e.g., a phase shifter) described based on the common knowledge in the technical field according to the present invention. Furthermore, each transmission/reception antenna 101 can be composed of an array antenna, for example. Furthermore, each transmitting/receiving section 103 is configured to be able to apply single BF and multiple BF.

Each transmitting/receiving section 103 may transmit a signal by using a transmission beam, and receive a signal by using a reception beam. Each transmitting/receiving section 103 may transmit and/or receive a signal by using a given beam determined by a control section 301.

Each transmitting/receiving section 103 may receive and/or transmit various pieces of information described in each of the above embodiments from the user terminal 20 and/or to the user terminal 20.

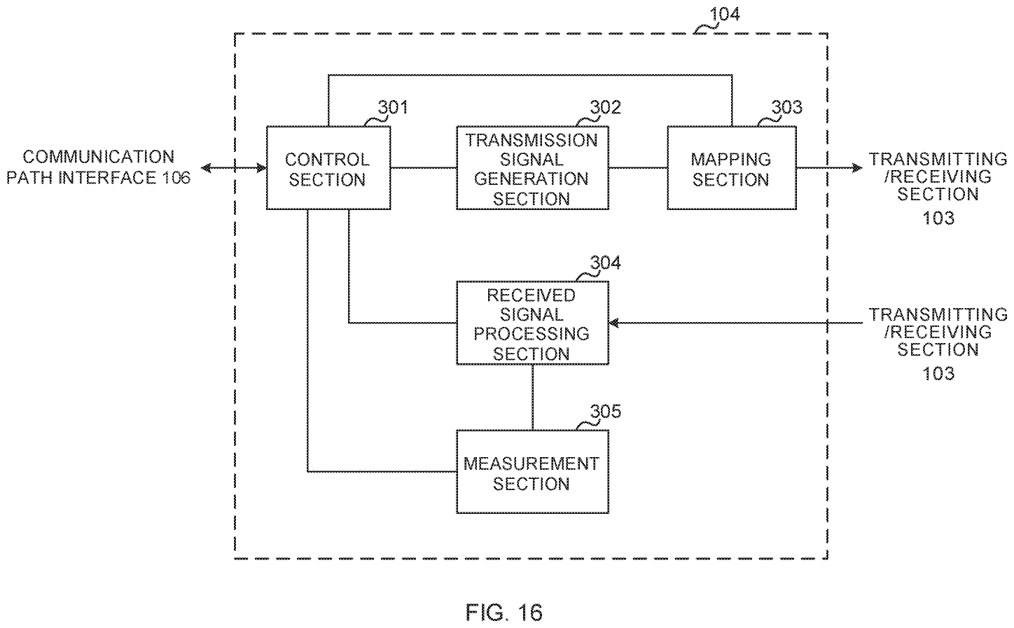

FIG. 16 is a diagram illustrating one example of a function configuration of the base station according to the one embodiment. In addition, this example mainly illustrates function blocks of characteristic portions according to the present embodiment, and may assume that the base station 10 includes other function blocks, too, that are necessary for radio communication.

The baseband signal processing section 104 includes at least the control section (scheduler) 301, a transmission signal generating section 302, a mapping section 303, a received signal processing section 304 and a measurement section 305. In addition, these components only need to be included in the base station 10, and part or all of the components may not be included in the baseband signal processing section 104.

The control section (scheduler) 301 controls the entire base station 10. The control section 301 can be composed of a controller, a control circuit or a control apparatus described based on the common knowledge in the technical field according to the present disclosure.

The control section 301 controls, for example, signal generation of the transmission signal generating section 302 and signal allocation of the mapping section 303. Furthermore, the control section 301 controls signal reception processing of the received signal processing section 304 and signal measurement of the measurement section 305.

The control section 301 controls scheduling (e.g., resource allocation) of system information, a downlink data signal (e.g., a signal that is transmitted on the PDSCH), and a downlink control signal (e.g., a signal that is transmitted on the PDCCH and/or the EPDCCH and is, for example, transmission acknowledgement information). Furthermore, the control section 301 controls generation of a downlink control signal and a downlink data signal based on a result obtained by deciding whether or not it is necessary to perform retransmission control on an uplink data signal.

The control section 301 controls scheduling of synchronization signals (e.g., PSS/SSS) and downlink reference signals (e.g., a CRS, a CSI-RS and a DMRS).

The control section 301 may perform control for forming a transmission beam and/or a reception beam by using digital BF (e.g., precoding) in the baseband signal processing section 104 and/or analog BF (e.g., phase rotation) in each transmitting/receiving section 103.

The transmission signal generating section 302 generates a downlink signal (such as a downlink control signal, a downlink data signal or a downlink reference signal) based on an instruction from the control section 301, and outputs the downlink signal to the mapping section 303. The transmission signal generating section 302 can be composed of a signal generator, a signal generating circuit or a signal generating apparatus described based on the common knowledge in the technical field according to the present disclosure.

The transmission signal generating section 302 generates, for example, a DL assignment for giving notification of downlink data allocation information, and/or a UL grant for giving notification of uplink data allocation information based on the instruction from the control section 301. The DL assignment and the UL grant are both DCI, and conform to a DCI format. Furthermore, the transmission signal generating section 302 performs encoding processing and modulation processing on the downlink data signal according to a code rate and a modulation scheme determined based on Channel State Information (CSI) from each user terminal 20.

The mapping section 303 maps the downlink signal generated by the transmission signal generating section 302, on given radio resources based on the instruction from the control section 301, and outputs the downlink signal to each transmitting/receiving section 103. The mapping section 303 can be composed of a mapper, a mapping circuit or a mapping apparatus described based on the common knowledge in the technical field according to the present disclosure.

The received signal processing section 304 performs reception processing (e.g., demapping, demodulation and decoding) on a received signal input from each transmitting/receiving section 103. In this regard, the received signal is, for example, an uplink signal (such as an uplink control signal, an uplink data signal or an uplink reference signal) transmitted from the user terminal 20. The received signal processing section 304 can be composed of a signal processor, a signal processing circuit or a signal processing apparatus described based on the common knowledge in the technical field according to the present disclosure.

The received signal processing section 304 outputs information decoded by the reception processing to the control section 301. When, for example, receiving the PUCCH including HARQ-ACK, the received signal processing section 304 outputs the HARQ-ACK to the control section 301. Furthermore, the received signal processing section 304 outputs the received signal and/or the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present disclosure.

For example, the measurement section 305 may perform Radio Resource Management (RRM) measurement or Channel State Information (CSI) measurement based on the received signal. The measurement section 305 may measure received power (e.g., Reference Signal Received Power (RSRP)), received quality (e.g., Reference Signal Received Quality (RSRQ), a Signal to Interference plus Noise Ratio (SINR) or a Signal to Noise Ratio (SNR)), a signal strength (e.g., a Received Signal Strength Indicator (RSSI)) or channel information (e.g., CSI). The measurement section 305 may output a measurement result to the control section 301.

In addition, each transmitting/receiving section 103 may transmit information for controlling transmission of uplink channels (e.g., PUSCHs or PUCCHs) to the user terminal 20. Each transmitting/receiving section 103 may receive the uplink channels (e.g., the PUSCHs or the PUCCHs).

(User Terminal)

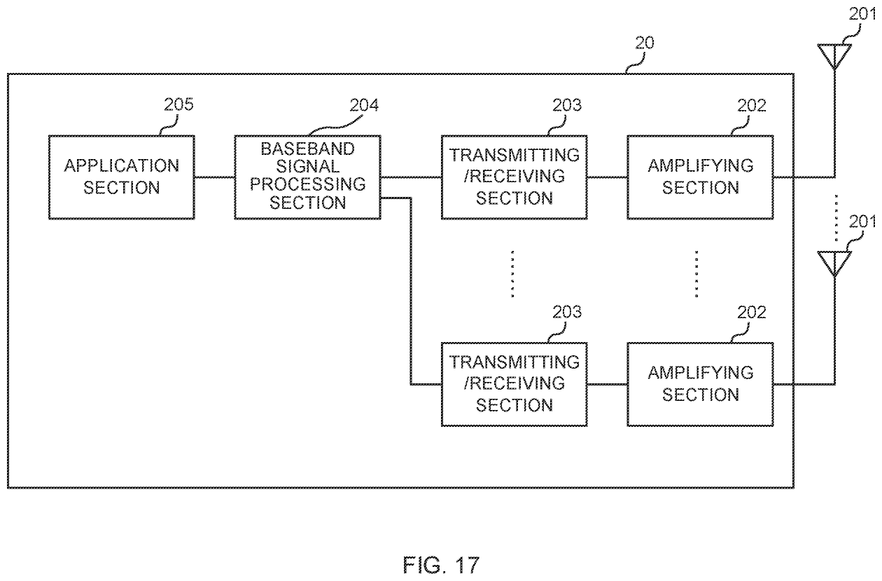

FIG. 17 is a diagram illustrating one example of an overall configuration of the user terminal according to the one embodiment. The user terminal 20 includes pluralities of transmission/reception antennas 201, amplifying sections 202 and transmitting/receiving sections 203, a baseband signal processing section 204 and an application section 205. In this regard, the user terminal 20 only needs to be configured to include one or more of each of the transmission/reception antennas 201, the amplifying sections 202 and the transmitting/receiving sections 203.

Each amplifying section 202 amplifies a radio frequency signal received at each transmission/reception antenna 201. Each transmitting/receiving section 203 receives a downlink signal amplified by each amplifying section 202. Each transmitting/receiving section 203 performs frequency conversion on the received signal into a baseband signal, and outputs the baseband signal to the baseband signal processing section 204. The transmitting/receiving sections 203 can be composed of transmitters/receivers, transmission/reception circuits or transmission/reception apparatuses described based on the common knowledge in the technical field according to the present disclosure. In this regard, the transmitting/receiving sections 203 may be composed as an integrated transmitting/receiving section or may be composed of transmitting sections and reception sections.

The baseband signal processing section 204 performs FFT processing, error correcting decoding and retransmission control reception processing on the input baseband signal. The baseband signal processing section 204 transfers downlink user data to the application section 205. The application section 205 performs processing related to layers higher than a physical layer and an MAC layer. Furthermore, the baseband signal processing section 204 may transfer broadcast information of the downlink data, too, to the application section 205.

On the other hand, the application section 205 inputs uplink user data to the baseband signal processing section 204. The baseband signal processing section 204 performs retransmission control transmission processing (e.g., HARQ transmission processing), channel coding, precoding, Discrete Fourier Transform (DFT) processing and IFFT processing on the uplink user data, and transfers the uplink user data to each transmitting/receiving section 203.

Each transmitting/receiving section 203 converts the baseband signal output from the baseband signal processing section 204 into a radio frequency range, and transmits a radio frequency signal. The radio frequency signal subjected to the frequency conversion by each transmitting/receiving section 203 is amplified by each amplifying section 202, and is transmitted from each transmission/reception antenna 201.

In addition, each transmitting/receiving section 203 may further include an analog beam forming section that performs analog beam forming. The analog beam forming section can be composed of an analog beam forming circuit (e.g., a phase shifter or a phase shift circuit) or an analog beam forming apparatus (e.g., a phase shifter) described based on the common knowledge in the technical field according to the present disclosure. Furthermore, each transmission/reception antenna 201 can be composed of an array antenna, for example. Furthermore, each transmitting/receiving section 203 is configured to be able to apply single BF and multiple BF.

Each transmitting/receiving section 203 may transmit a signal by using a transmission beam, and receive a signal by using a reception beam. Each transmitting/receiving section 203 may transmit and/or receive a signal by using a given beam determined by a control section 401.

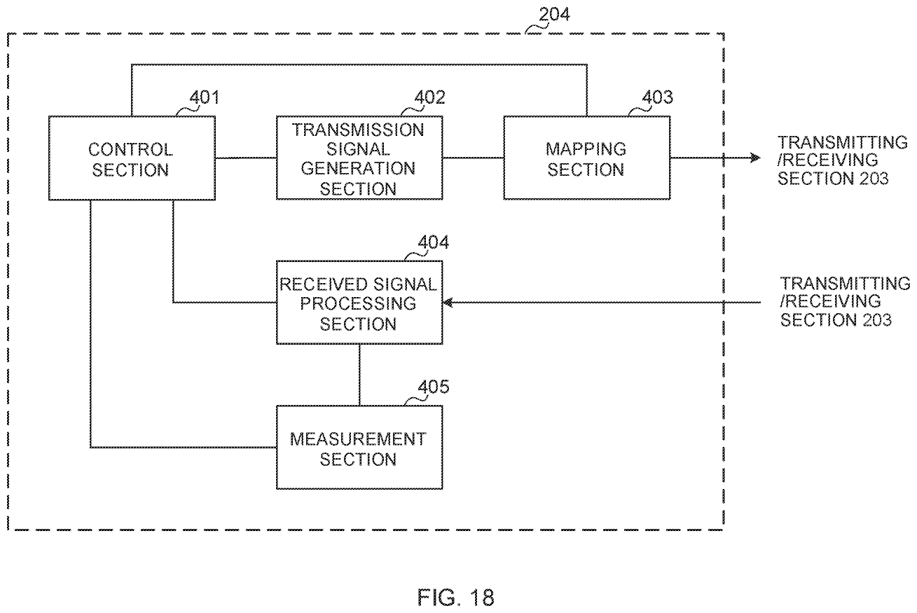

FIG. 18 is a diagram illustrating one example of a function configuration of the user terminal according to the one embodiment. In addition, this example mainly illustrates function blocks of characteristic portions according to the present embodiment, and may assume that the user terminal 20 includes other function blocks, too, that are necessary for radio communication.

The baseband signal processing section 204 of the user terminal 20 includes at least the control section 401, a transmission signal generating section 402, a mapping section 403, a received signal processing section 404 and a measurement section 405. In addition, these components only need to be included in the user terminal 20, and part or all of the components may not be included in the baseband signal processing section 204.

The control section 401 controls the entire user terminal 20. The control section 401 can be composed of a controller, a control circuit or a control apparatus described based on the common knowledge in the technical field according to the present disclosure.

The control section 401 controls, for example, signal generation of the transmission signal generating section 402 and signal allocation of the mapping section 403. Furthermore, the control section 401 controls signal reception processing of the received signal processing section 404 and signal measurement of the measurement section 405.

The control section 401 obtains from the received signal processing section 404 a downlink control signal and a downlink data signal transmitted from the base station 10. The control section 401 controls generation of an uplink control signal and/or an uplink data signal based on a result obtained by deciding whether or not it is necessary to perform retransmission control on the downlink control signal and/or the downlink data signal.

The control section 401 may perform control for forming the transmission beam and/or the reception beam by using digital BF (e.g., preceding) of the baseband signal processing section 204, and/or analog BF (e.g., phase rotation) of each transmitting/receiving section 203.

Furthermore, when obtaining from the received signal processing section 404 various pieces of information notified from the base station 10, the control section 401 may update parameters used for control based on the various pieces of information.

The transmission signal generating section 402 generates an uplink signal (such as an uplink control signal, an uplink data signal or an uplink reference signal) based on an instruction from the control section 401, and outputs the uplink signal to the mapping section 403. The transmission signal generating section 402 can be composed of a signal generator, a signal generating circuit or a signal generating apparatus described based on the common knowledge in the technical field according to the present disclosure.

The transmission signal generating section 402 generates, for example, an uplink control signal related to transmission acknowledgement information and Channel State Information (CSI) based on the instruction from the control section 401. Furthermore, the transmission signal generating section 402 generates an uplink data signal based on the instruction from the control section 401. When, for example, the downlink control signal notified from the base station 10 includes a UL grant, the transmission signal generating section 402 is instructed by the control section 401 to generate an uplink data signal.

The mapping section 403 maps the uplink signal generated by the transmission signal generating section 402, on radio resources based on the instruction from the control section 401, and outputs the uplink signal to each transmitting/receiving section 203. The mapping section 403 can be composed of a mapper, a mapping circuit or a mapping apparatus described based on the common knowledge in the technical field according to the present disclosure.

The received signal processing section 404 performs reception processing (e.g., demapping, demodulation and decoding) on the received signal input from each transmitting/receiving section 203. In this regard, the received signal is, for example, a downlink signal (such as a downlink control signal, a downlink data signal or a downlink reference signal) transmitted from the base station 10. The received signal processing section 404 can be composed of a signal processor, a signal processing circuit or a signal processing apparatus described based on the common knowledge in the technical field according to the present disclosure. Furthermore, the received signal processing section 404 can compose the reception section according to the present disclosure.

The received signal processing section 404 outputs information decoded by the reception processing to the control section 401. The received signal processing section 404 outputs, for example, broadcast information, system information, an RRC signaling and DCI to the control section 401. Furthermore, the received signal processing section 404 outputs the received signal and/or the signal after the reception processing to the measurement section 405.

The measurement section 405 performs measurement related to the received signal. The measurement section 405 can be composed of a measurement instrument, a measurement circuit or a measurement apparatus described based on the common knowledge in the technical field according to the present disclosure.

For example, the measurement section 405 may perform RRM measurement or CSI measurement based on the received signal. The measurement section 405 may measure received power (e.g., RSRP), received quality (e.g., RSRQ, an SINR or an SNR), a signal strength (e.g., RSSI) or channel information (e.g., CSI). The measurement section 405 may output a measurement result to the control section 401.

In addition, each transmitting/receiving section 203 may receive the information for controlling transmission of the uplink channels (e.g., the PUSCHs or the PUCCHs). The information may be, for example, PUSCH configuration information (a “PUSCH-Config” information element of RRC), PUCCH configuration information (a “PUCCH-Config” of RRC) or DCI (e.g., DCI format 0_0 or 0_1).

Each transmitting/receiving section 203 may transmit the uplink channels (e.g., PUSCHs or PUCCHs).

When being instructed to transmit a first uplink channel and a second uplink channel in overlapping durations (simultaneous transmission duration), the control section 401 may transmit one of the first and second uplink channels in the durations. The control section 401 may perform control to transmit part or all of the rest of symbols that do not overlap the above durations among symbols of the other one of the first and second uplink channels.

The control section 401 performs control not to transmit a given number of symbols before or after the durations among the rest of symbols.

When all Sounding Reference Signal (SRS) Resource Indices (SRIs) indicated by downlink control information for scheduling the first uplink channel and the second uplink channel correspond to SRS resources having a spatial relation with specific signals, and indices of the specific signals associated with these SRS resources are different, the control section 401 may assume that transmission beams of the first uplink channel and the second uplink channel are different.

When the control section 401 does not have a beam correspondence, the control section 401 may control transmission of the uplink channels in a plurality of cells assuming that an association between Sounding Reference Signal (SRS) resource indices indicated by the downlink control information used for scheduling of the uplink channels, and the transmission beams is the same in each cell. Furthermore, when the control section 401 is instructed to transmit the uplink channels in a plurality of cells in the overlapping durations, and when the SRS resource indices indicated by the downlink control information used for scheduling of the respective uplink channels are the same, the control section 401 may assume that transmission beams of the respective uplink channels are identical.

The specific signal may be at least one of an SSB, a CSI-RS and an SRS. Furthermore, the assumption may be possible in at least one of a case where the user terminal 20 holds the beam correspondence and a case where the user terminal 20 does not hold the beam correspondence.

(Hardware Configuration)

In addition, the block diagrams used to describe the above embodiments illustrate blocks in function units. These function blocks (components) are realized by an arbitrary combination of at least ones of hardware components and software components. Furthermore, a method for realizing each function block is not limited in particular. That is, each function block may be realized by using one physically or logically coupled apparatus or may be realized by using a plurality of these apparatuses formed by connecting two or more physically or logically separate apparatuses directly or indirectly (by using, for example, wired connection or radio connection). Each function block may be realized by combining software with the above one apparatus or a plurality of above apparatuses.

In this regard, the functions include judging, determining, deciding, calculating, computing, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning, yet are not limited to these. For example, a function block (component) that causes transmission to function may be referred to as a transmitting unit or a transmitter. As described above, the method for realizing each function block is not limited in particular.

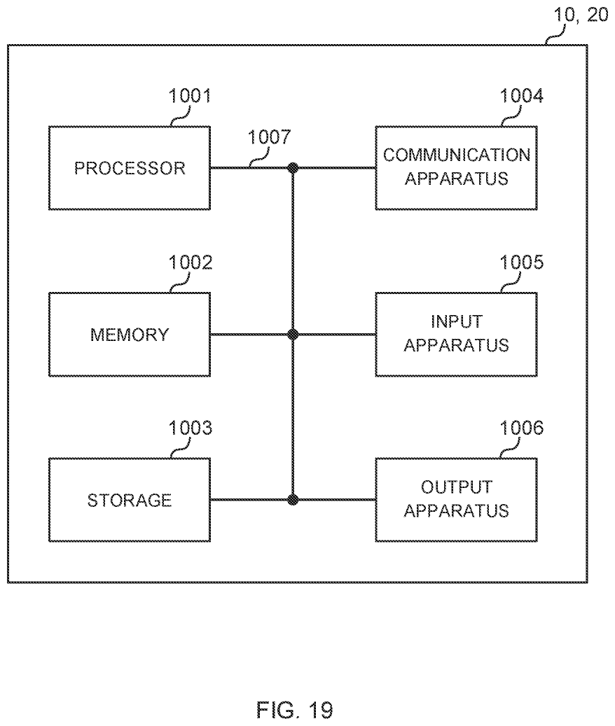

For example, the base station and the user terminal according to the one embodiment of the present disclosure may function as computers that perform processing of the radio communication method according to the present disclosure. FIG. 19 is a diagram illustrating one example of the hardware configurations of the base station and the user terminal according to the one embodiment. The above-described base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, words such as an apparatus, a circuit, a device, a section and a unit in the present disclosure can be interchangeably read. The hardware configurations of the base station 10 and the user terminal 20 may be configured to include one or a plurality of apparatuses illustrated in FIG. 19 or may be configured without including part of the apparatuses.

For example, FIG. 19 illustrates the only one processor 1001. However, there may be a plurality of processors. Furthermore, processing may be executed by 1 processor or processing may be executed by 2 or more processors simultaneously or successively or by using another method. In addition, the processor 1001 may be implemented by 1 or more chips.

Each function of the base station 10 and the user terminal 20 is realized by, for example, causing hardware such as the processor 1001 and the memory 1002 to read given software (program), and thereby causing the processor 1001 to perform an operation, and control communication via the communication apparatus 1004 and control at least one of reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from at least one of the storage 1003 and the communication apparatus 1004 out to the memory 1002, and executes various types of processing according to these programs, software module or data. As the programs, programs that cause the computer to execute at least part of the operations described in the above-described embodiments are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to perform the radio communication method according to the one embodiment of the present disclosure.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via at least one of a wired network and a radio network, and is also referred to as, for example, a network device, a network controller, a network card and a communication module. The communication apparatus 1004 may be configured to include a high frequency switch, a duplexer, a filter and a frequency synthesizer to realize at least one of, for example, Frequency Division Duplex (FDD) and Time Division Duplex (TDD). For example, the above-described transmission/reception antennas 101 (201), amplifying sections 102 (202), transmitting/receiving sections 1103 (203) and communication path interface 106 may be realized by the communication apparatus 1004. Each transmitting/receiving section 103 (203) may be physically or logically separately implemented as a transmitting section 103a (203a) and a reception section 103b (203b).

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. hi addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or entirety of each function block. For example, the processor 1001 may be implemented by using at least one of these hardware components.

(Modified Example)

In addition, each term that has been described in the present disclosure and each term that is necessary to understand the present disclosure may be replaced with terms having identical or similar meanings. For example, a channel, a symbol and a signal (a signal or a signaling) may be interchangeably read. Furthermore, a signal may be a message. A reference signal can be also abbreviated as an RS (Reference Signal), or may be referred to as a pilot or a pilot signal depending on standards to be applied. Furthermore, a Component Carrier (CC) may be referred to as a cell, a frequency carrier and a carrier frequency.

A radio frame may include one or a plurality of durations (frames) in a time domain. Each of one or a plurality of durations (frames) that makes up a radio frame may be referred to as a subframe. Furthermore, the subframe may include one or a plurality of slots in the time domain. The subframe may be a fixed time duration (e.g., 11 ms) that does not depend on the numerologies.

In this regard, the numerology may be a communication parameter to be applied to at least one of transmission and reception of a certain signal or channel. The numerology may indicate at least one of, for example, a SubCarrier Spacing (SOS), a bandwidth, a symbol length, a cyclic prefix length, a Transmission Time Interval (TTI), the number of symbols per TTI, a radio frame configuration, specific filtering processing performed by a transceiver in a frequency domain, and specific windowing processing performed by the transceiver in a time domain.

The slot may include one or a plurality of symbols (Orthogonal Frequency Division Multiplexing (OFDM) symbols or Single Carrier-Frequency Division Multiple Access (SC-FDMA) symbols) in the time domain. Furthermore, the slot may be a time unit based on the numerologies.

The slot may include a plurality of mini slots. Each mini slot may include one or a plurality of symbols in the time domain. Furthermore, the mini slot may be referred to as a subslot. The mini slot may include a smaller number of symbols than those of the slot. The PDSCH (or the PUSCH) to be transmitted in larger time units than that of the mini slot may be referred to as a PDSCH (PUSCH) mapping type A. The PDSCH (or the PUSCH) to be transmitted by using the mini slot may be referred to as a PDSCH (PUSCH) mapping type B.

The radio frame, the subframe, the slot, the mini slot and the symbol each indicate a time unit for conveying signals. The other corresponding names may be used for the radio frame, the subframe, the slot, the mini slot and the symbol. In addition, time units such as a frame, a subframe, a slot, a mini slot and a symbol in the present disclosure may be interchangeably read.

For example, 1 subframe may be referred to as a Transmission Time interval (III), a plurality of contiguous subframes may be referred to as TTI, or 1 slot or 1 mini slot may be referred to as a TTI. That is, at least one of the subframe and the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling of radio communication. For example, in the LTE system, the base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block or codeword, or may be a processing unit of scheduling or link adaptation. In addition, when the TTI is given, a time period (e.g., the number of symbols) in which a transport block, a code block or a codeword is actually mapped may be shorter than the TTI.

In addition, when 1 slot or 1 mini slot is referred to as a TTI, 1 or more TTI (i.e., 1 or more slots or 1 or more mini slots) may be a minimum time unit of scheduling. Furthermore, the number of slots (the number of mini slots) that make up a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe, a long subframe or a slot. A TTI shorter than the general TTI may be referred to as a reduced a short TTI, a partial or fractional TTI, a reduced subframe, a short subframe, a mini slot, a subslot or a slot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

A Resource Block (RB) is a resource allocation unit of the time domain and the frequency domain, and may include one or a plurality of contiguous subcarriers in the frequency domain. The numbers of subcarriers included in RBs may be the same irrespectively of a numerology, and may be, for example, 12. The numbers of subcarriers included in the RBs may be determined based on the numerology.

Furthermore, the RB may include one or a plurality of symbols in the time domain or may have the length of 1 slot, 1 mini slot, 1 subframe or 1 TTI. 1 TTI or 1 subframe may each include one or a plurality of resource blocks.

In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

A Bandwidth Part (BWP) (that may be referred to as a partial bandwidth) may mean a subset of contiguous common Resource Blocks (common RBs) for a certain numerology in a certain carrier. In this regard, the common RB may be specified by RB index based on a common reference point of the certain carrier, A PRB may be defined based on a certain BWP, and may be numbered in the certain BWP.

The BWP may include a BWP for UL (UL BWP) and a BWP for DL (DL BWP). One or a plurality of BWPs in 1 carrier may be configured to the UE.

At least one of the configured BWPs may be active, and the UE may not assume that a given signal/channel is transmitted and received outside the active BWP. In addition, a “cell” and a “carrier” in the present disclosure may be read as a “BWP”.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and the parameters described in the present disclosure may be expressed by using absolute values, may be expressed by using relative values with respect to given values or may be expressed by using other corresponding information. For example, a radio resource may be instructed by a given index.

Names used for parameters in the present disclosure are in no respect restrictive names. Furthermore, numerical expressions that use these parameters may be different from those explicitly disclosed in the present disclosure. Various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in the present disclosure may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or arbitrary combinations of these.

Furthermore, the information and the signals can be output at least one of from a higher layer to a lower layer and from the lower layer to the higher layer. The information and the signals may be input and output via a plurality of network nodes.

The input and output information and signals may be stored in a specific location (e.g., memory) or may be managed by using a management table. The information and signals to be input and output can be overridden, updated or additionally written. The output information and signals may be deleted. The input information and signals may be transmitted to other apparatuses.

Notification of information is not limited to the aspect/embodiments described in the present disclosure and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (a Master Information Block (MIB) and a System information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit. notification, and may be given implicitly (by, for example, not giving notification of the given information or by giving notification of another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using at least ones of wired techniques (e.g., coaxial cables, optical fiber cables, twisted pairs and Digital Subscriber Lines (DSLs)) and radio techniques (e.g., infrared rays and microwaves), at least ones of these wired techniques and radio techniques are included in a definition of the transmission media.

The terms “system” and “network” used in the present disclosure can be interchangeably used.

the present disclosure, terms such as “precoding”, a “precoder”, a “weight (precoding weight)”, “Quasi-Co-Location (QCL)”, a “Transmission Configuration Indication state (TCI State)”, a “spatial relation”, a “spatial domain filter”, “transmission power”, “phase rotation”, an “antenna port”, an “antenna port group”, a “layer”, “the number of layers”, a “rank”, a “resource”, a “resource set”, a “resource group”, a “beam”, a “beam width”, a “beam angle”, an “antenna”, an “antenna element” and a “panel” can be interchangeably used.

In the present disclosure, terms such as a “base Station (BS)”, a “radio base station”, a “fixed station”, a “NodeB”, an “eNodeB (eNB)”, a “gNodeB (gNB)”, an “access point”, a “Transmission Point (TP)”, a “Reception Point (RP)”, a “Transmission/Reception Point (TRP)”, a “pane”, a “cell”, a “sector”, a “cell group”, a “carrier” and a “component carrier” can be interchangeably used. The base station is also referred to as terms such as a macro cell, a small cell, a femtocell or a picocell.

The base station can accommodate one or a plurality of (e.g., three) cells. When the base station accommodates a plurality of cells, an entire coverage area of the base station can be partitioned into a plurality of smaller areas. Each smaller area can also provide a communication service via a base station subsystem (e.g., indoor small base station (RRH: Remote Radio Head)). The term “cell” or “sector” indicates part or the entirety of the coverage area of at least one of the base station and the base station subsystem that provide a communication service in this coverage.

In the present disclosure, the terms such as “Mobile Station (MS)”, “user terminal”, “user apparatus (UE: User Equipment)” and “terminal” can be interchangeably used.

The mobile station is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

At least one of the base station and the mobile station may be referred to as a transmission apparatus, a reception apparatus or a communication apparatus. In addition, at least one of the base station and the mobile station may be a device mounted on a movable body or the movable body itself. The movable body may be a vehicle (e.g., a car or an airplane), may be a movable body (e.g., a drone or a self-driving car) that moves unmanned or may be a robot (a manned type or an unmanned type). In addition, at least one of the base station and the mobile station includes an apparatus, too, that does not necessarily move during a communication operation. For example, at least one. of the base station and the mobile station may be an Internet of Things (IoT) device such as a sensor.

Furthermore, the base station in the present disclosure may be read as the user terminal. For example, each aspect/embodiment of the present disclosure may be applied to a configuration where communication between the base station and the user terminal is replaced with communication between a plurality of user terminals (that may be referred to as, for example, Device-to-Device (D2D) or Vehicle-to-Everything (V2X)). In this case, the user terminal 20 may be configured to include the functions of the above-described base station 10. Furthermore, words such as “uplink” and “downlink” may be read as a word (e.g., a “side”) that matches terminal-to-terminal communication. For example, the uplink channel and the downlink channel may be read as side channels.

Similarly, the user terminal in the present disclosure may be read as the base station. In this case, the base station 10 may be configured to include the functions of the above-described user terminal 20.

In the present disclosure, operations performed by the base station are performed by an upper node of this base station depending on cases. Obviously, in a network including one or a plurality of network nodes including the base stations, various operations performed to communicate with a terminal can be performed by base stations, one or more network nodes (that are regarded as, for example, Mobility Management Entities (MMEs) or Serving-Gateways (S-GWs), yet are not limited to these) other than the base stations or a combination of these.

Each aspect/embodiment described in the present disclosure may be used alone, may be used in combination or may be switched and used when carried out. Furthermore, orders of the processing procedures, the sequences and the flowchart according to each aspect/embodiment described in the present disclosure may be rearranged unless contradictions arise. For example, the method described in the present disclosure presents various step elements by using an exemplary order and is not limited to the presented specific order.

Each aspect/embodiment described in the present disclosure may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 80211. (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods, or next-generation systems that are expanded based on these systems. Furthermore, a plurality of systems may be combined (e.g., a combination of LTE or LTE-A and 5G) and applied.

The phrase “based on” used in the present disclosure does not mean “based only on” unless specified otherwise. In other words, the phrase “based on” means both of “based only on” and “based at least on”.

Every reference to elements that use names such as “first” and “second” used in the present disclosure does not generally limit the quantity or the order of these elements. These names can be used in the present disclosure as a convenient method for distinguishing between two or more elements. Hence, the reference to the first and second elements does not mean that only two elements can be employed or the first element should precede the second element in some way.

The term “deciding (determining)” used in the present disclosure includes diverse operations in some cases. For example, “deciding (determining)” may be regarded to “decide (determine)” judging, calculating, computing, processing, deriving, investigating, looking up, search and inquiry (e.g., looking up in a table, a database or another data structure), and ascertaining.

Furthermore, “deciding (determining)” may be regarded to “decide (determine)” receiving (e.g., receiving information), transmitting (e.g., transmitting information), input, output and accessing (e.g., accessing data in a memory).

Furthermore, “deciding (determining)” may be regarded to “decide (determine)” resolving, selecting, choosing, establishing and comparing. That is, “deciding (determining)” may be regarded to “decide (determine)” some operation.

Furthermore, “deciding (determining)” may be read as “assuming”, “expecting” and “considering”.

The words “connected” and “coupled” used in the present disclosure or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections, For example, “connection” may be read as “access”.

It can be understood in the present disclosure that, when connected, the two elements are “connected” or “coupled” with each other by using 1 or more electric wires, cables or printed electrical connection, and by using electromagnetic energy having wavelengths in radio frequency domains, microwave domains or (both of visible and invisible) light domains in some non-restrictive and non-comprehensive examples.

A sentence that “A and B are different” in the present disclosure may mean that “A and B are different from each other”. In this regard, the sentence may mean that “A and B are each different from C”. Words such as “separate” and “coupled” may be also interpreted in a similar way to “different”.

When the words “include” and “including” and modifications of these words are used in the present disclosure, these. words intend to be comprehensive similar to the word “comprising”. Furthermore, the word “or” used in the present disclosure intends not to be an exclusive OR.

When, for example, translation adds articles such as a, an and the in English in the present disclosure, the present disclosure may include that nouns coming after these articles are plural.

The invention according to the present disclosure has been described in detail above. However, it is obvious for a person skilled in the art that the invention according to the present disclosure is not limited to the embodiments described in the present disclosure. The invention according to the present disclosure can be carried out as modified and changed aspects without departing from the gist and the scope of the. invention defined based on the. recitation of the claims. Accordingly, the description of the present disclosure is intended for exemplary explanation, and does not bring any restrictive meaning to the invention according to the present disclosure.

1. A user terminal comprising:
a receiving section that receives information for controlling transmission of an uplink channel; and
a control section that, when transmission of a first uplink channel and a second uplink channel is instructed in overlapping durations, performs control to transmit one of the first and second uplink channels in the durations, and further transmit a rest of symbols that do not overlap the durations among symbols of other one of the first and second uplink channels.

2. The user terminal according to claim 1, wherein the control section performs control not to transmit a given number of symbols before or after the durations among the rest of symbols.

3. The user terminal according to claim 1, wherein, when all resource indices of Sounding Reference Signals (SRSs) correspond to SRS resources having a spatial relation with specific signals, and indices of the specific signals associated with the SRS resources are different, the control section assumes that transmission beams of the first uplink channel and the second uplink channel are different, the resource indices of the sounding reference signals being indicated by downlink control information for scheduling the first uplink channel and the second uplink channel.

4. A radio communication method of a user terminal comprising:
receiving information for controlling transmission of an uplink channel; and
when transmission of a first uplink channel and a second uplink channel is instructed in overlapping durations, performing control to transmit one of the first and second uplink channels in the durations, and further transmit a rest of symbols that do not overlap the durations among symbols of other one of the first and second uplink channels.

5. The user terminal according to claim 2, wherein, when all resource indices of Sounding Reference Signals (SRSs) correspond to SRS resources having a spatial relation with specific signals, and indices of the specific signals associated with the SRS resources are different, the control section assumes that transmission beams of the first uplink channel and the second uplink channel are different, the resource indices of the sounding reference signals being indicated by downlink control information for scheduling the first uplink channel and the second uplink channel.
